(19) United States
(12) Patent Application Publication
(10) Pub. No.: US 2023/0121927 A1
(43) Pub. Date: Apr. 20, 2023

(54) SYSTEMS AND METHODS ASSOCIATED WITH COMPUTER- IMPLEMENTED PLATFORMS INVOLVING VIDEO, MOBILE, GUI- RELATED, BID-BASED AND/OR OTHER FEATURES

(71) Applicant: VidyPros, Inc., San Carlos, CA (US)

(72) Inventors: Joon Oh, San Carlos, CA (US); Thomas Schaffernoth, San Carlos, CA (US); Edwar Habr, San Carlos, CA (US); Wilbur Liang, San Carlos, CA (US)

(21) Appl. No.: 17/976,759

(22) Filed: Oct. 29, 2022

Related U.S. Application Data
(63) Continuation of application No. PCT/US2021/054070, filed on Oct. 7, 2021.
(60) Provisional application No. 63/088,965, filed on Oct. 7, 2020.

(51) Int. Cl. G06Q 30/015; G06Q 10/0631; G06Q 10/0639

(52) U.S. Cl. CPC G06Q 30/015; G06Q 10/0639; G06Q 10/06313

(57) ABSTRACT

Systems and methods associated with computer-implemented platforms involving video, mobile, GUI-related, bid-based, and/or other features are disclosed. According to certain illustrative implementations, one exemplary method may include generating a project request including a video, the video describing a project with one or more project details, transmitting the project request to a server for processing, and receiving feedback information from the server, the feedback information associated with servicing the project request. Numerous other systems, methods, and computer-readable media innovations are also disclosed.

### CROSS-REFERENCE TO RELATED APPLICATION(S) INFORMATION

This is a continuation (bypass) of PCT International application No. PCT/US2021/054070, filed Oct. 7, 2021, published as WO2022/076758A1, and claims priority to U.S. Provisional Pat. Application No. 63/088,965, filed Oct. 7, 2021, which is incorporated herein by reference in entirety.

### FIELD

The present disclosure generally relates to improved computer-based systems, methods, platforms and user interfaces, and particularly to, improved computer-based systems, methods, platforms and user interfaces associated with service provision that are driven by various technological features and functionality, including video creation and viewing, among others. Aspects of the disclosed technology and platforms here may comprise and/or involve processes of creating and viewing videos, such as those associated with acquiring and/or providing a bid or quote, and may include a user in the role of a client on a network platform as connecting with other users acting as service providers. Systems and methods herein may include and/or involve the leveraging of various individual technological solutions and/or combinations thereof to create a networked computer system and/or platform that facilitates user connections that provide technical solutions associated with enabling service providers to provide specialized, computer-implemented functionality, such as bids including quotes, for services needed by the client.

### OVERVIEW OF SOME ASPECTS OF DESCRIBED SUBJECT MATTER

As set forth in the various illustrative embodiments described below, the present disclosure provides exemplary technically improved computer-based processes, systems and computer program products associated with or involving obtaining bids or quotes for desired services, such as technical solutions including those that are driven by video creation and viewing. According to some embodiments, the disclosed technology may include or involve processes of creating and viewing videos to acquire a bid or quote, including aspects involving a user in the role of a customer client on the network platform as connected with other users acting as service providers. These systems and methods leverage various individual technological solutions and the combining of them to create a network platform that facilitates user connections that allow service provider clients to give customer clients bids or quotes for services requested by the customer client. The disclosed technology and/or network platforms herein replace the existing and labor-intensive approach with technologically-advanced solutions that leverages a variety of technologies, artificial intelligence, video, messaging, and scheduling features and functionality to resolve issues and drawbacks that exist in such outdated solutions.

According to some embodiments, the video driven communication to allow the client to submit a project and a service provider to review and provide estimate for the project provides for improved communication via the capability for the client/service provider to annotate the video content with voice memo, images, etc. In some other embodiments, the AI provided at the embodiments of the platform further provides improved techniques in matching client and client’s project with one or more appropriate and competent service providers.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a diagram illustrating a known process.

FIG. 2 is a block diagram illustrating an exemplary system and/or platform, consistent with exemplary aspects of certain embodiments of the present disclosure.

FIG. 3 is a block diagram illustrating an exemplary system and/or platform, consistent with exemplary aspects of certain embodiments of the present disclosure.

FIG. 4 is a block diagram illustrating an exemplary system and/or platform, consistent with exemplary aspects of certain embodiments of the present disclosure.

FIG. 5 is a diagram illustrating an exemplary system and/or platform, consistent with exemplary aspects of certain embodiments of the present disclosure.

FIG. 6 is a block illustrating an exemplary system and/or platform, consistent with exemplary aspects of certain embodiments of the present disclosure.

FIGS. 7A-F is a series of flowcharts illustrating an exemplary methodology, consistent with exemplary aspects of certain embodiments of the present disclosure.

FIG. 8 is a diagram illustrating an exemplary system, consistent with exemplary aspects of certain embodiments of the present disclosure.

FIG. 9 is a flowchart illustrating one exemplary process, consistent with exemplary aspects of certain embodiments of the present disclosure.

FIG. 10 is a flowchart illustrating one exemplary process, consistent with exemplary aspects of certain embodiments of the present disclosure.

FIG. 11 is a flowchart illustrating one exemplary process, consistent with exemplary aspects of certain embodiments of the present disclosure.

FIG. 12 is a diagram illustrating one exemplary process, consistent with exemplary aspects of certain embodiments of the present disclosure.

FIG. 13 is a diagram illustrating one exemplary process, consistent with exemplary aspects of certain embodiments of the present disclosure.

FIG. 14 is a diagram illustrating one exemplary process, consistent with exemplary aspects of certain embodiments of the present disclosure.

FIGS. 15A-15B are a series of exemplary user interfaces, including features and functionality for a service provider client, consistent with exemplary aspects of certain embodiments of the present disclosure.

FIGS. 16A-16B are a series of exemplary user interfaces including features and functionality for a client, consistent with exemplary aspects of certain embodiments of the present disclosure.

FIGS. 17A-17B are a series of exemplary user interfaces including features and functionality for a client, consistent with exemplary aspects of certain embodiments of the present disclosure.

FIGS. 18A-18D are a series of exemplary user interfaces including features and functionality for a service provider, consistent with exemplary aspects of certain embodiments of the present disclosure.

FIGS. 19A-19B are a series of exemplary user interfaces including features and functionality for a client, consistent with exemplary aspects of certain embodiments of the present disclosure.

FIGS. 20A-20B are a series of exemplary user interfaces including features and functionality for a service provider, consistent with exemplary aspects of certain embodiments of the present disclosure.

FIG. 21 illustrates a series of exemplary user interfaces including features and functionality for a client, consistent with exemplary aspects of certain embodiments of the present disclosure.

FIGS. 22A-22H illustrates a series of another exemplary user interfaces including features and functionality for a client, consistent with exemplary aspects of certain embodiments of the present disclosure.

FIGS. 23A-23J illustrates a series of another exemplary user interfaces including features and functionality for a service provider, consistent with exemplary aspects of certain embodiments of the present disclosure.

### DETAILED DESCRIPTION

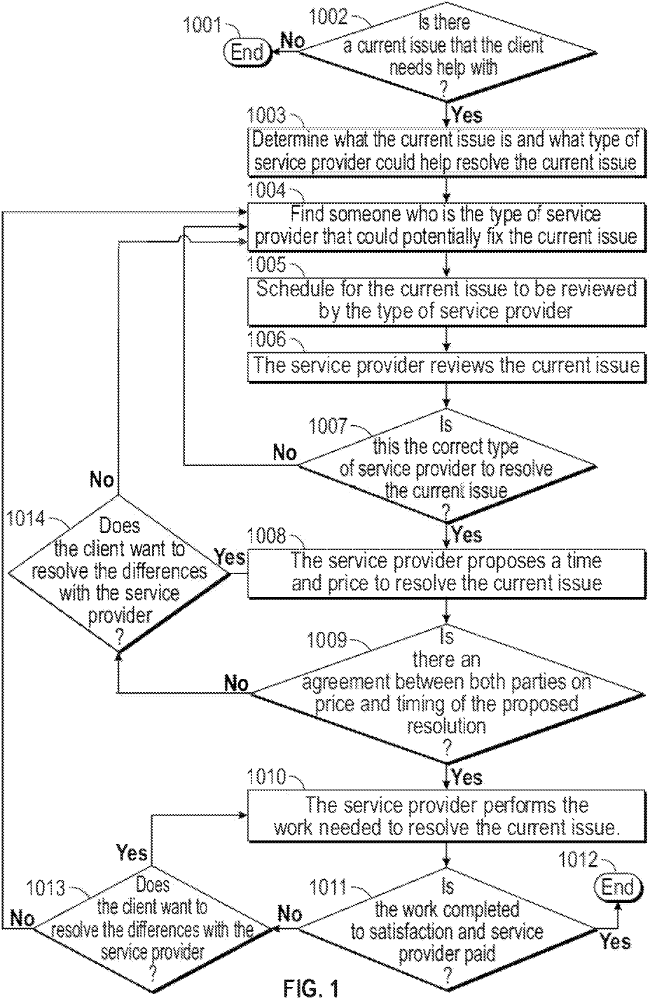

When someone needs to get help, in their residence as an example, for a specific issue; they often need to find someone such as a service provider to help them in resolving the issue. FIG. 1 is a block diagram of an inefficient current process illustrating challenges that a customer would experience in getting help in solving their project’s needs. The present inventions, however, replace such traditional non-technical solutions and involve technical innovations including embodiments which, among other things, can improve and even simplify the process/solution that is represented in FIG. 1. Referring to FIG. 1, a labor-intensive process of finding someone to help them is illustrated. The process starts at 1002, “Is there a current issue that the Client needs help with?”

In FIG. 1, at 1003, an individual determines how they might fix an issue that they have. Someone cannot resolve the issue themselves, they need help. They need someone else to help them, and they will need to go through several steps in order to resolve the current issue they are facing, as shown in callouts 1004 through 1006 of FIG. 1.

One of the tasks that someone needs to perform is to determine what specifically is the issue, and what type of service provider do I need to help fix this particular issue. There are times when through trial and error someone tries to answer these types of questions to resolve their specific issue.

FIG. 1, callout 1004 represents a lot of work that someone has to do in order to find someone who is a service provider to help them to resolve their current issue. Under the premise that the person has chosen the correct type of service provider to contact, they will need to research and find someone to help them. This could involve searching on-line to see who in their area could potentially be available to visit their location where this issue exists. Someone would possibly have to talk with friends to get their advice on who to contact for help. Someone would use an existing service like Yelp.com to search for local service providers to try and reach out to in order to discuss their issue.

Once someone finds a service provider they believe could potentially solve their issue, there would need to be an agreement on the time that the proposed service provider would come to the issues’ location to observe the issue so as to propose the efforts and financial requirement to solve the current issue. FIG. 1, callout 1005 notes this.

While the service provider is at the location of the issue, they will observe the issue to determine if this is indeed an issue that they themselves could even resolve. This is noted in FIG. 1, at 1007.

If the service provider is the wrong type of service provider to resolve the current issue, then the process reverts back to step 1004 in FIG. 1. This can be a very time-consuming process and cause someone a lot of angst in trying to resolve their current issue.

Once the correct service provider is on location and can determine what the issue is and what is required to fix the issue, then the service provider will propose the financial resource cost, and the timing for when the resolution of the current issue will happen. See FIG. 1, callout 1008.

One of the many challenges that can occur when trying to find a service provider to resolve an issue is the agreement on the cost and when the service provider can be on-site to perform the work. This could be a very iterative process. See FIG. 1, callout 1014. A service provider could provide an appropriate cost, but scheduling a time to perform the work would not be acceptable. In FIG. 1, at 1009, there is a risk of having to find a new service provider if some type of agreement over cost and timing could not be satisfactorily met by both parties.

Once an agreement has been made that meets the satisfaction of both parties, then the service provider must perform the work to an acceptable level. See FIG. 1, at 1010. This work takes time and requires various types of attention at various stages by both parties.

After the work is completed per the service provider’s perspective, the other party needs to agree that the work performed is acceptable to resolve the current issue. If so, then the service provider will need to be paid accordingly with an agreed-upon financial medium. See FIG. 1, at 1011. If there cannot be an agreement about the work performed and completion to resolve the current issue, there could possibly be a need to find another service provider. See FIG. 1, at 1013.

The goal being the satisfactory resolution of the current issue by both parties. Once that satisfaction is met, then FIG. 1, in callout 1012 indicates the end of the current issue and the need for attention by either party.

In FIG. 1, the conclusion of 1001 indicates that there is no longer an issue that the customer or client will need any help.

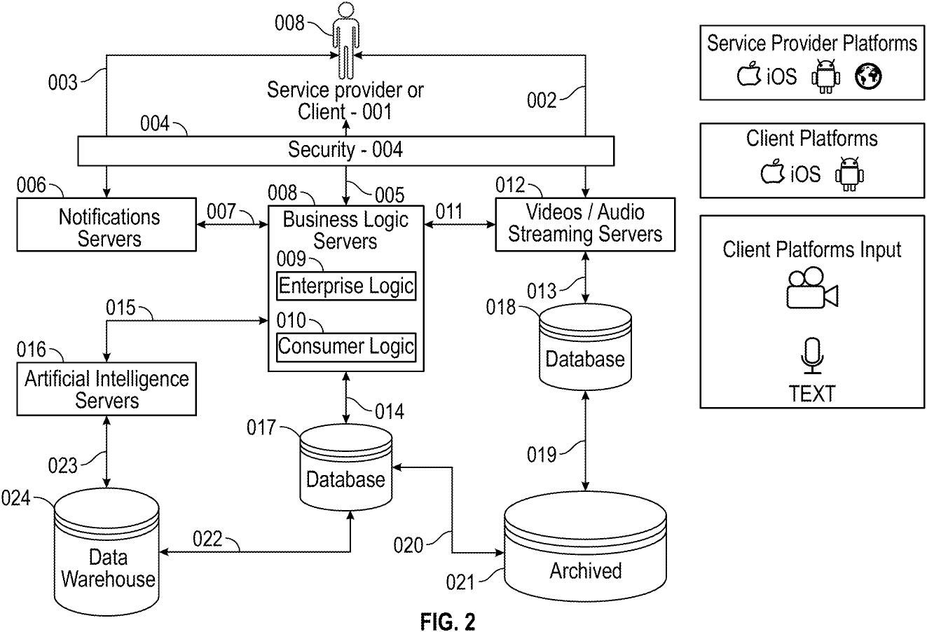

FIG. 2 illustrates one illustrative overall system architecture of the disclosed technology including an exemplary service platform, in accordance with certain embodiments of the present disclosure. As shown herein, FIG. 2 depicts various components of one exemplary platform consistent with the disclosed technology. The components start with the indicator for a service provider or a customer / client 001. The illustrative platform’s process starts with 001 of a customer or client initiating a video that represents the customer’s needs of their project. Once the customer records the project video, that video is then sent initially in FIG. 2 to callouts 008, and 012 that allows new projects and the video content itself is then stored in the appropriate databases, e.g. at 018 and 017.

Once the video is stored on the present platform, the Business Logic Servers 008 of FIG. 2 may communicate with other platform processing resources, such the Artificial Intelligence Server 016, to determine the content of the video. Determining the content of the will allow the illustrative platform to offer suggestions to both the Service Provider 001 and the Customer 001 or Client 001 suggestions on what to remember in dealing with this type of project. Knowing and understanding the content of the video will provide opportunities for the Business Logic Server 008 to send to the Service Provider 001 potential material cost and location of the martial components to be used on this project.

The Business Logic Server 008 on FIG. 2 will communicate to the Notifications Server 006 that some type of activity had occurred on the Client or Customer 001's project. Once the Notifications Server 006 is made aware of the project’s activity, it may respond accordingly to each Service Provider 001 and/or the Customer 001 depending upon type of activity that occurred for the project and who originated that activity.

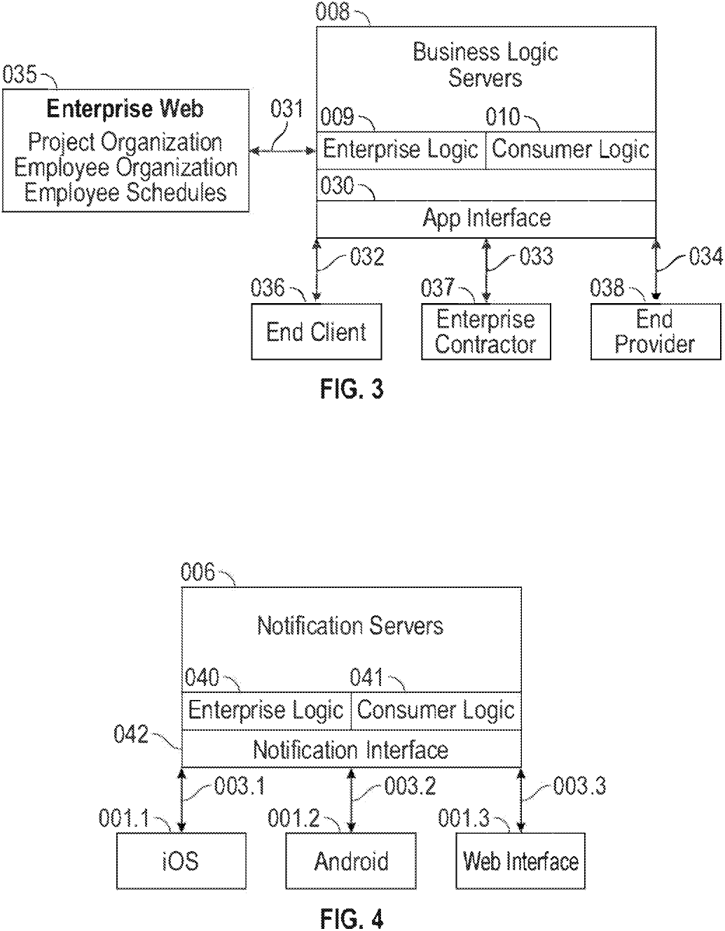

FIG. 3 illustrates an exemplary layout of the components for the Business Logic Architecture. Key parts of such exemplary business logic involve how aspects of the consumer and enterprises are handled on the system and/or platform. The business logic for the consumer aspect may take the form of a more straightforward approach when compared to the business logic of the enterprise aspect. The complexity lies with the number of people involved per project and the roles they will play on the system and/or platform consistent with exemplary aspects of certain embodiments of the present disclosure. As shown herein, the business logic server 008 includes both an enterprise logic 009 and a consumer logic 010, both of which configured with an app interface 030 to communicate 032, 034, and 036 with end client 036, enterprise contractor 037, and end provider 038, respectively. An enterprise web 035 is also provided to communicate 031 with the enterprise logic 009.

FIG. 3 shows some exemplary Business Logic Architecture (including callouts 008, 009, 010, 035, 030, 032, 033, 034, 036, 037, 038) that may give insight into the way all the Clients, the Client’s projects, and the Service Providers are handled on the illustrative platform. Some main actors or types of users on the illustrative platform are the Client 036, and the Service Provider 038. There is also another unique type of user on the platform and that is the Enterprise Contractor 037. The Enterprise Contractor may play the role more of a project manager and a layer abstracted from the Client 036. The Enterprise Contractor will handle multiple projects with multiple project locations. In some embodiments, an App Interface may perform various interfacing with the three previously defined types of users on the illustrative platform. The various channels between the types of users, 036, 037, 038, and the App Interface 030, are fairly straightforward, as shown via callouts 032, 033, 034. The Consumer Logic 010 will leverage the App Interface 030, to communicate all details regarding a project from the Client and the Service Provider’s perspective. Such communications may be effected via any manner of communication media, such as in video, audio, email, text, social media, messaging, etc. formats, for a particular client’s project. Another abstracted layer is included as well for the Enterprise Web 035 which communicates through a channel 031 that interfaces with the Enterprise Logic 009, which may ultimately handle Projects and Service Providers that work on those projects.

FIG. 4 is a block diagram illustrating an exemplary system and/or platform regarding how each user on the system and/or platform will be made aware when events occur that would be of value or importance to them. In some embodiments, various significant activity by the consumer or the service provider on the system and/or platform will generate notifications for the others involved regarding a consumer’s project consistent with exemplary aspects of certain embodiments of the present disclosure. In FIG. 4, a layout of the components for the Notification Servers 006 is shown. Via notification servers 006, each user on the system and/or platform will be made aware when events occur that would be of value or importance to them. Any significant activity by the consumer or the service provider on the system and/or platform will generate notifications for the others involved regarding a consumer’s project consistent with exemplary aspects of certain embodiments of the present disclosure. As shown herein, the notification server 006 includes an enterprise logic 040, and a consumer logic 041, both of which are configured with a notification interface 042 to notify (or otherwise communicate with) various computing devices 003.1, 003.2, and 003.3 a iOS client 001.1, an Android client 001.2, and a web interface 001.3, respectively.

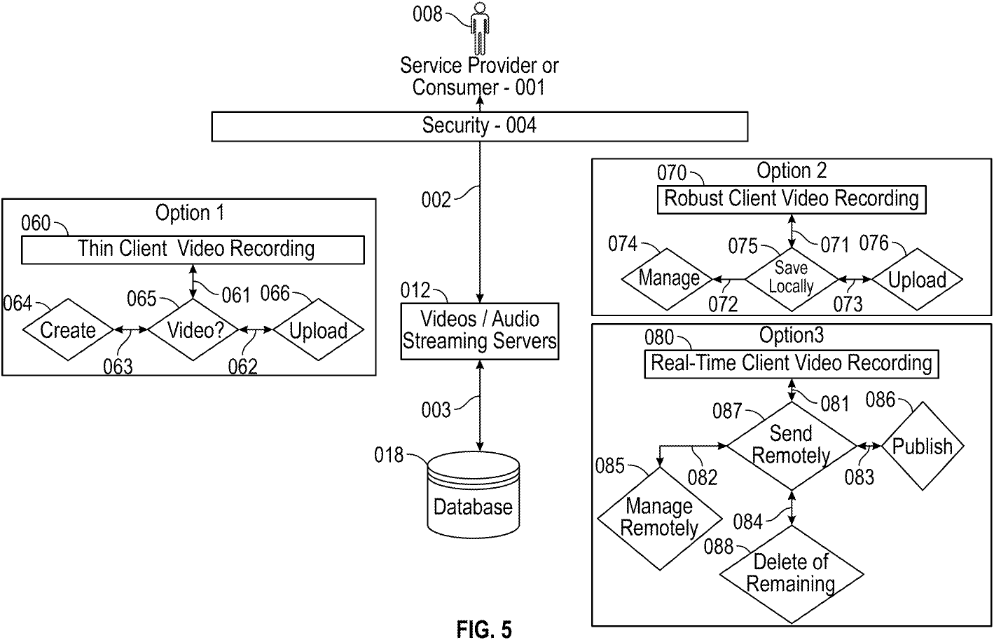

FIG. 5 is a diagram illustrating an exemplary system and/or platform regarding how the videos are managed on the system and/or platform. The videos, e.g. which may be taken by either the consumer or the service provider regarding a project, may be handled by the system and/or platform represented in FIG. 5 consistent with the exemplary aspects of certain embodiments of the present disclosure.

In FIG. 5, a layout of the components for the Videos / Audio Streaming components and progression of the mobile client’s 001 progression of functionalities are shown. Via the components illustrated herein, videos are managed on the system and/or platform. The videos that are taken by either the consumer or the service provider regarding a project will be handled by the system and/or platform represented in FIG. 5 consistent with the exemplary aspects of certain embodiments of the present disclosure. As shown herein, a service provider or consumer 001 may provide video/audio streams in multiple ways to transmit to video/audio streaming server 012, which in turn may store information, at 013, into a database 018. In option 1, a thin client video recording technique 060 is used 061 to create 064 video 065 for upload 066 to the server. In option 2, a robust client video recording 070 is used 071 to manage 074, save locally 075, or upload 076 to the server. In option 3, real time client video recording techniques 080 is used 081 to manage remotely 085, send remotely 087, publish 086, or delete some or all remaining 088 of the video/audio captured.

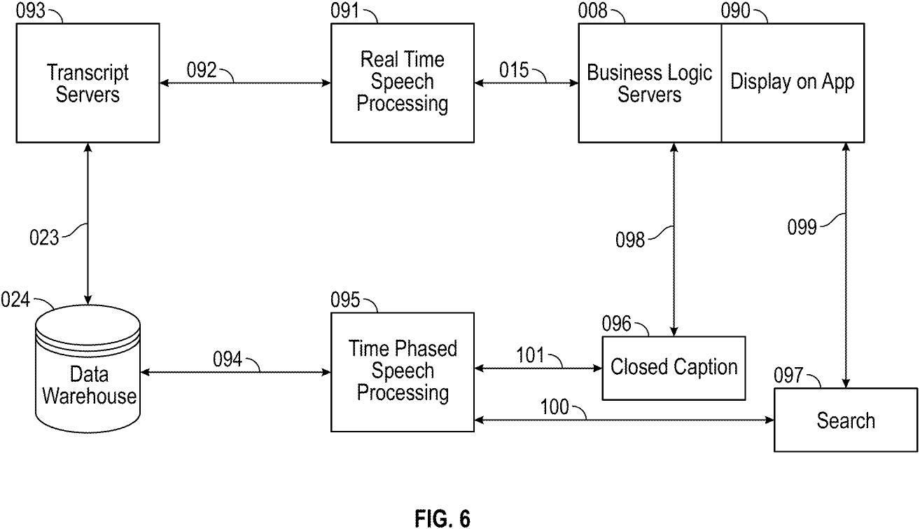

FIG. 6 is a block illustrating an exemplary system and/or platform regarding how the artificial intelligence is incorporated into the system and/or platform. The artificial intelligence will provide a number of features such as, processing the video content in real-time to gain insights into the project’s material and labor needs, educate both the consumers and the service providers on what is important for the type of project, and matching consumers with the best possible service provider for the consumer and their project’s needs, consistent with exemplary aspects of certain embodiments of the present disclosure.

In FIG. 6, one exemplary layout of components for the Artificial Intelligence Architecture of the illustrative platform is shown. In various embodiments, Artificial Intelligence (AI) is incorporated into the system and/or platform. The artificial intelligence will provide a number of features such as, processing the video content in real-time to gain insights into the project’s material and labor needs, educate both the consumers and the service providers on what is important for the type of project, and matching consumers with the best possible service provider for the consumer and their project’s needs, consistent with exemplary aspects of certain embodiments of the present disclosure. As shown herein, the business logic servers 008 communicate 015 via real time speech processing 091 application/tool to communicate 092 with a transcript server 093. The transcript server 093 is configured with a data warehouse 024, which facilitates 094 time phased speech processing 095 application/tool that provides 101 closed caption 096 to be rendered 098 at a display of an app 090. The time phased speech processing application /tool 095 also provides for search application/too 097 that is in communication 099 with the display of the app 090.

Referring to FIG. 6, Artificial Intelligence (AI) Servers includes callouts 008, 090, 099, 098, 097, 096, 101, 100, 095, 094, 024, 023, 093, 092, 091, 015. In some embodiments, one of the main AI roles on the illustrative platform is to match Service Providers with Clients and their projects. This not simply a location-based service. Such implementations involve processing data for various Clients and their projects along with matching Service Providers that were successful in handling Client’s projects. The data will be sorted and matched accordingly. In some embodiments, part of the AI engine may process audio from all the videos and storing that audio as digital text. Based on textual content either positive, neutral, or negative, this content will contribute to the matching algorithm between future Client and Service Providers. In addition, all of the text communications in the messaging threads revolving around a project by the Client and the Service Provider may also be processed. This matching ability will also go to match project needs or supplies needed to potential suppliers for the project. Here, callout 024 is the data warehouse that will store all data needed to drive the AI engine for the illustrative platform callout 024 will communicate between callout 093, Transcript Servers, and callout 095, the Time Phased Speech Processingcallout 093 will handle all the text processing and storing of the data that originates with the Real-Time Speech Processing component 091. Time Phased Speech Processing 095 may involve more delayed processing of the textual data, e.g., data regarding which more time is needed to analyze and gain insight into the data. Ultimately deeper analysis for providing all text data from the audio content that will be updated on the Client and Service Providers platforms.

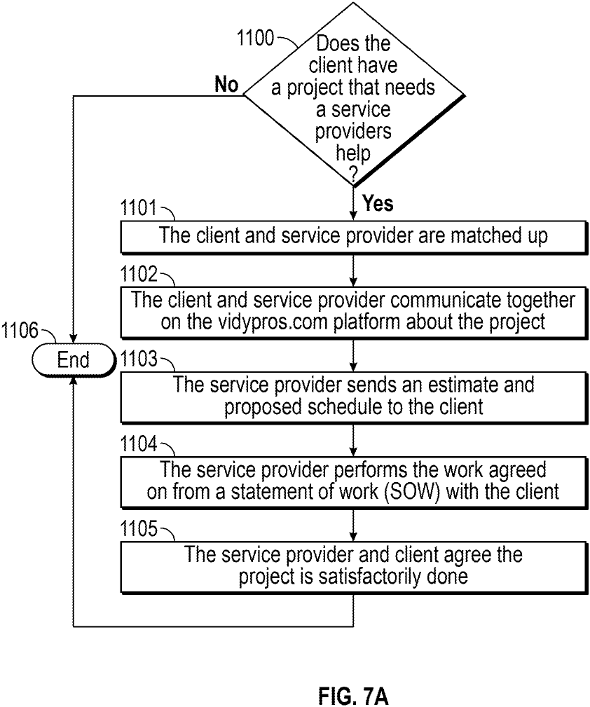

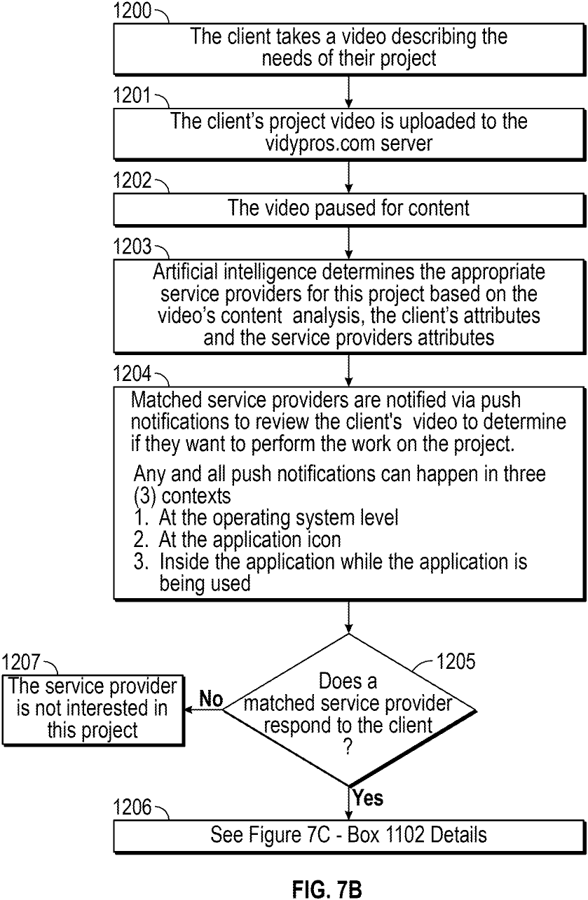

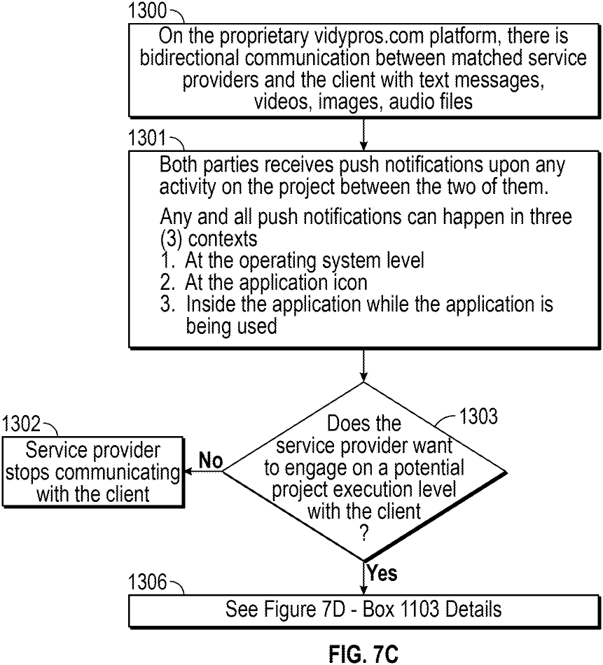

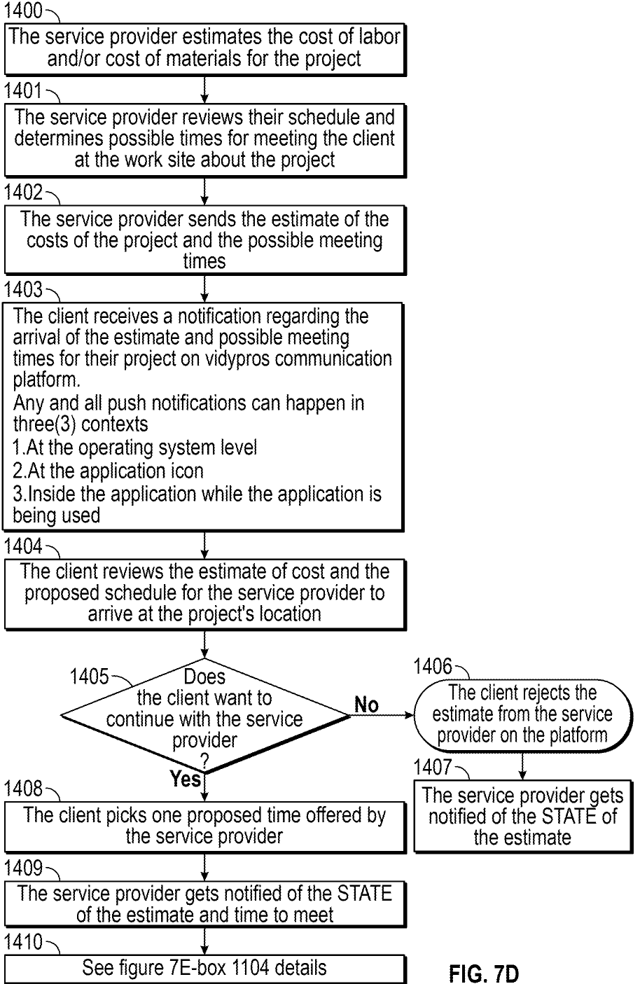

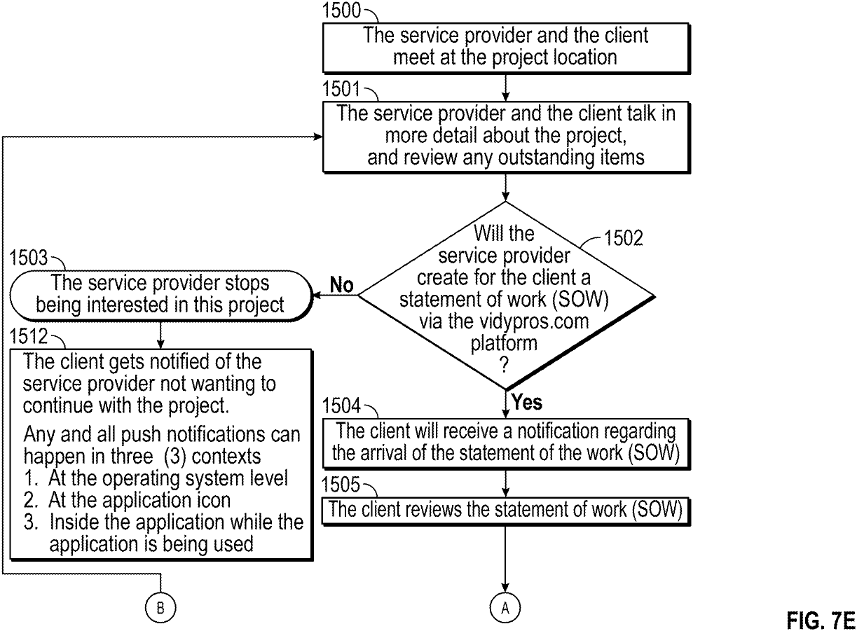

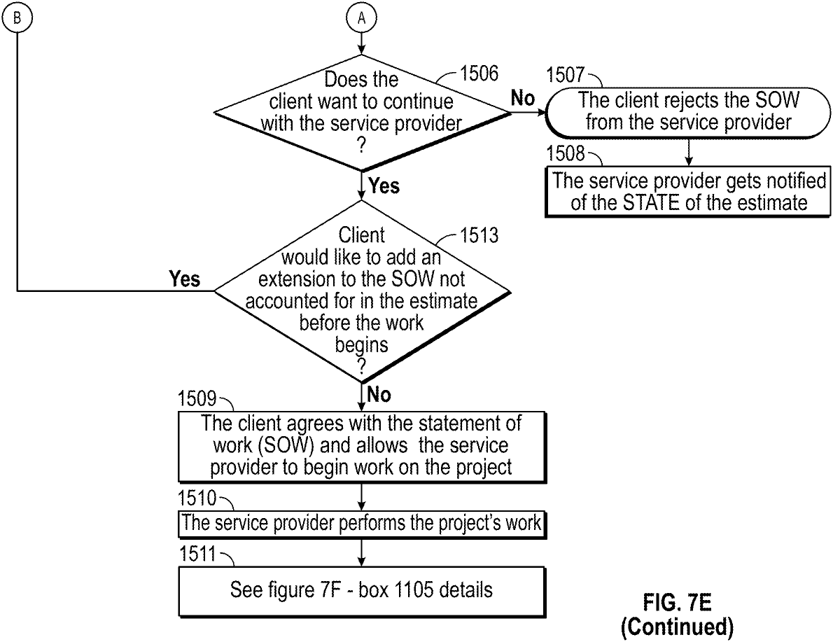

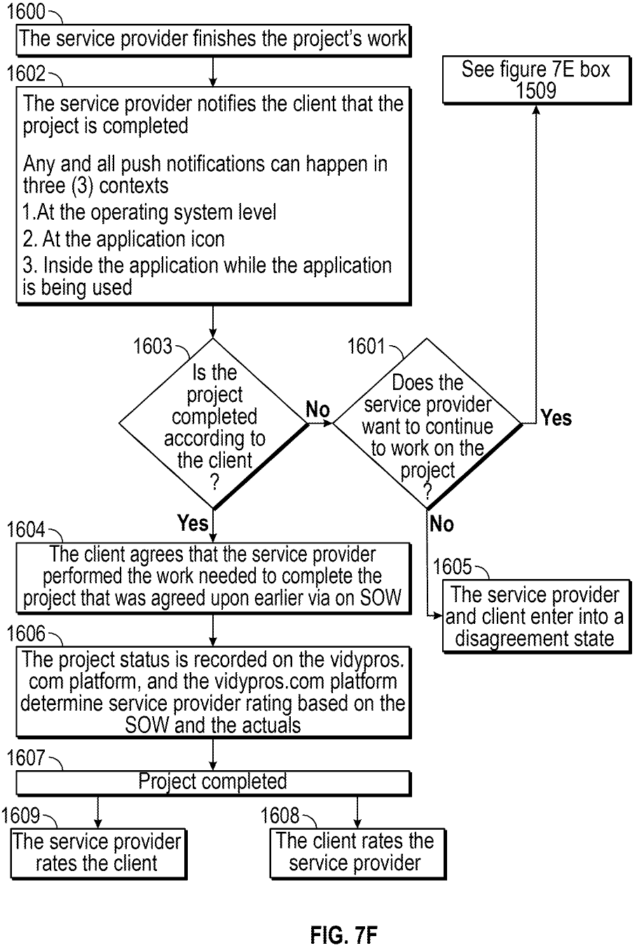

FIGS. 7A-F are a series of flowcharts illustrating exemplary processes related to a client finding a service provider to successfully work on the client’s project, consistent with exemplary aspects of certain embodiments of the present disclosure. The first top-level process in FIG. 7A, after the initiation step 1100, is step 1101, which involves the Client and Service Provider being matched up to solve the Client’s issue or project using the illustrative platform processing herein, such as solutions driven by Artificial Intelligence. Additional detail of step 1101 of FIG. 7A is set forth and described in connection with FIG. 7B.

The second top-level process in FIG. 7A, is step 1102, which represents the Client and Service Provider communicating (e.g., via video, audio, text, social media, messaging, etc. options) on the illustrative platform. Such functionality provides the Client and Service Provider an easy means to communicate about a variety of issues related to the project that the Client needs help in resolving. Additional detail regarding this step 1102 is set forth in FIG. 7C.

The third top-level process in FIG. 7A, is step 1103, which highlights that the Service Provider can send to the Client a very detailed and structured estimate for the cost and time it would take to finish the Client’s project. Additional detail of this step 1103 is set forth in FIG. 7D.

The fourth top-level process in FIG. 7A, is step 1104, which highlights that the Service Provider may perform the work that is needed for the Client’s project that is outlined in an agreed-upon Statement of Work (SOW) by both the Client and the Service Provider. Additional detail of this step 1104 is set forth in FIG. 7E.

The fifth and final top-level process in FIG. 7A, is step 1105, which illustrates that the Service Provider and the Client may agree that the project is completed satisfactorily to the items defined in the Statement of Work (SOW), e.g., the SOW that was previously agreed upon by both the Client and the Service Provider. Additional detail of step 1105 is set forth in FIG. 7F.

The END of this illustrative process is marked in FIG. 7A, at step 1106. Here, for example, the project may come to an end once both the Client and Service Provider indicate or agree that the project is completed.

Turning to another illustrative process, the disclosed technology includes various features and functionality associated with trying to match a Client to a Service Provider. FIG. 7B illustrates aspects of the beginning of matching a Client with a Service Provider, where an initial step of the matching process may begin with a Client taking a video of the project that needs to be done for them, at 1200. Here, for example, the Client may take a video and during the video explain whatever the issue or project it is that they need help with. This video will be the basis and beginning of how the project gets incorporated into the illustrative platform. The video will be recorded within the Client application.

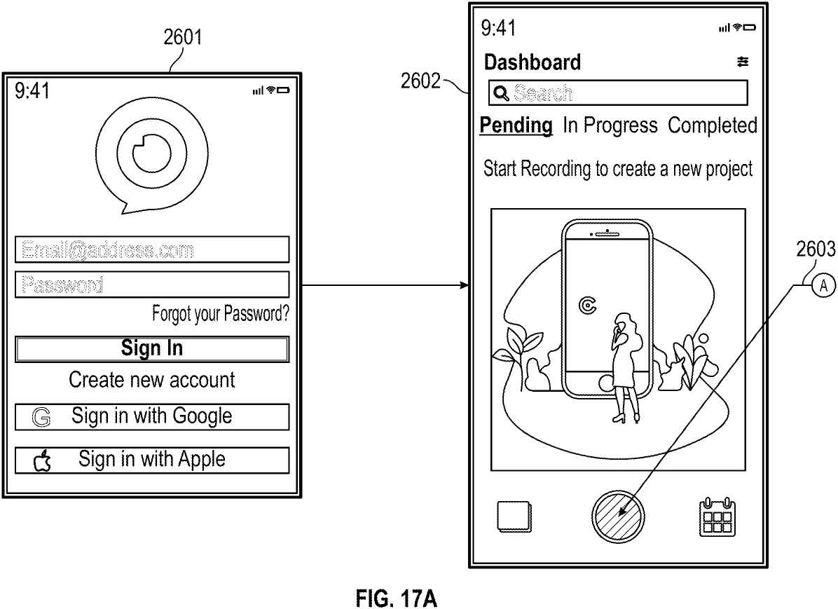

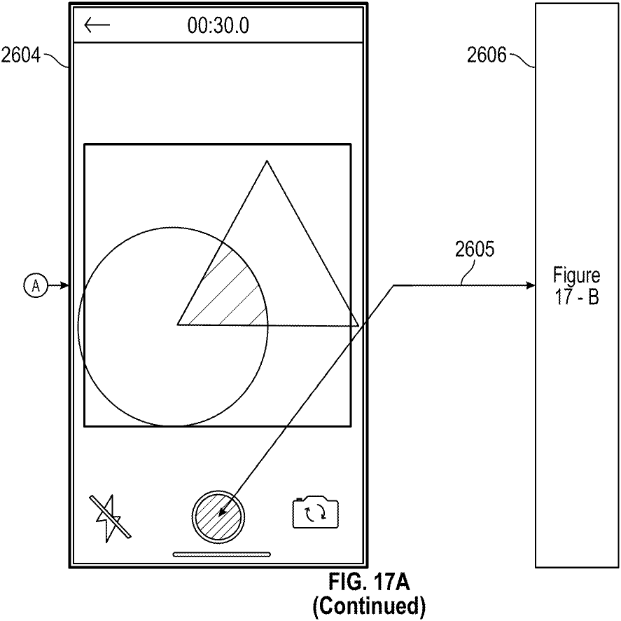

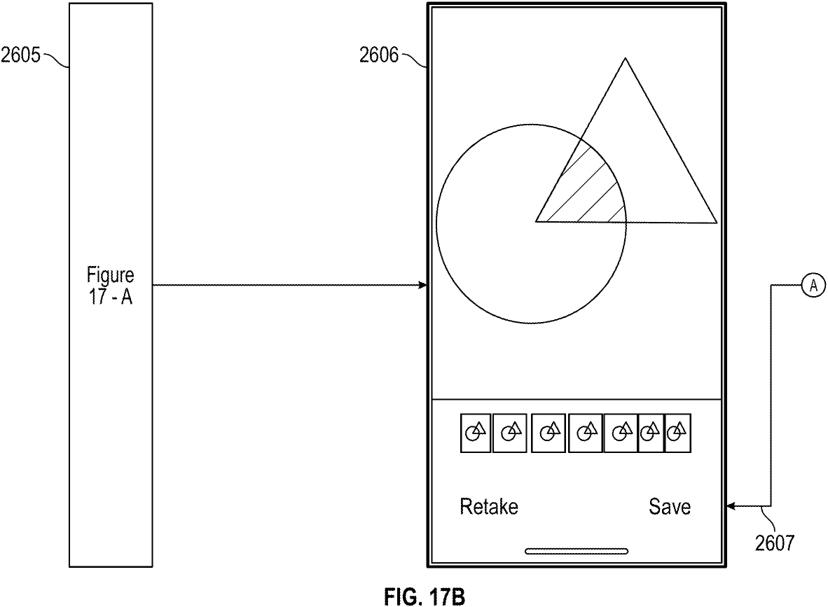

FIGS. 17A-17B, described below, illustrate a series of exemplary user interfaces associated with a client creating a project.

Referring back to FIG. 7B, the process of uploading the Client’s video to the illustrative platform is captured in callout 1201 in FIG. 7B. This video can be uploaded by any means that the mobile device has a connection to the Internet. Cell data and/or local area networks will provide access to the present Video Servers that are represented in FIG. 2 Overall Architecture callout 012. The Video Servers will then use communication 013 to transfer the video to the Database System callout 018. Now, the Video can be stored on the file system along with entries in the database that are related to the Video that is associated with this particular project and Client.

Once the Client’s video has been loaded up to present video server, the content of the video may be parsed for its content, at step 1202 of FIG. 7B. Here, for example, the content of the video may be passed as input to the Artificial Intelligence Servers, e.g., servers 016 of FIG. 2. The Artificial Intelligence Server 016 may include processing to parse out the audio content of the video and translate that content to text. Such task(s) may be accomplished by the Transcript Servers 93 on the FIG. 6 Artificial Intelligence Servers.

As the Artificial Intelligence Server 016 on FIG. 2 is processing the video’s content, additional algorithms may be executed that will receive and process the Client’s project’s various attributes and the Service Provider’s various attributes to determine which Service Provider has the best opportunity to be successful with the Client’s project.

Once the Artificial Intelligence Server 016 of FIG. 2 determines the most optimal Service Providers for the Client’s project, both the Client and Service Provider can be made aware of this potential matches or suggestions.

According to certain embodiments herein, the presently-disclosed platform may also be focused on ensuring that both the Client and the Service Provider are notified quickly when any events happen on the platform that would be important to either the Service Provider or the Client. The platform accomplishes this notification ability through the use of the Notifications Servers 006 of FIG. 2. These Notification servers may be configured to process notifications via various computer platforms, such as the World Wide Web (WWW), the mobile computing platforms of Android and Apple’s iOS, etc. Such notification processing can be seen in more detail on FIG. 4 Notifications System Architecture with callout 001.1 for iOS, callout 001.2 for Android, and callout 001.3 for the WWW. As noted in connection with the Notifications System Architecture 42 of FIG. 3, there is a layer or interface that deals with these three computer platforms for both the Client and the Service Provider. Also, the connections between the Notification Interface and the three computer platforms are represented as connections 003.1, 003.2, 003.3 in the Notifications System Architecture of FIG. 4. Such connections may be by cellular network or local area network for the computer platforms for both the Client and the Service Provider, among other communication means and media.

The notifications for each of the Client’s and Service Provider’s computer platforms that will receive them, WWW, Android, and iOS can have up to three specific ways these notifications are communicated to the end-user. A notification can happen at the Operating System level, at the application icon level, and inside the application itself. Please see step 1204 in FIG. 7B.

Once the Service Provider has been notified of the project’s potential, the Service Provider may make a decision whether to respond to the Client’s project on the present platform or not. That decision is represented in step 1205 of FIG. 7B, which illustrates the details of step 1101 of FIG. 7A. This response can happen at any time. The risk that the Service Provider takes in delaying the decision or response is that another Service Provider could have already communicated to the Client on the present platform that they would be interested to work on the Client’s project. The idea about this new and improved process on the present platform allows the Service Provider to quickly and easily make the decision and respond via a desired communication medium, such as text, video, audio, etc.

If the Service Provider decides to not respond to the Client’s project video and opportunity, the project will be removed from the Service Provider’s list of potential projects. This decision of not responding to the Client’s video is represented in FIG. 7B at step 1207.

If the Service Provider decides to respond, then as can be seen, via FIG. 7B step 1206, that the process on the present platform continues.

Referring next to the activity of both the Service Provider and the Client, they both will start to use the present platform to communicate back and forth regarding the Client’s project. This is initially represented in step 1300 of FIG. 7C, which illustrates details of step 1102 of FIG. 7A. This ability to communicate back and forth can be in various forms, including video, audio, and text, among others.

With regard to Video and Audio communications, the Service Provider or the Client can make their own videos or audio recordings to communicate anything regarding the project, such as questions, comments, directions, basically anything that they can record. The video or audio recording may be stored on the present platform. FIG. 5 (Videos / Audio Streaming) is a diagram representing various exemplary options and methods that will be used on the present platform for the amount of functionality and logic is provided for the videos and audio recordings themselves. Of the examples shown in FIG. 5, Video Option 1 - Thin Client (Computer Platform) Video Recording 060 illustrates that any user (Service Provider or Client) can create a video 064 and then upload that video 066 to the Videos/Audio Streaming Servers 012. The videos that are uploaded are optimally stored in database 018, and the local file system on callout 012. In the next example of FIG. 5, Video Option 2 - Robust Video Recording 070 provides the user (both Client and Service Provider) the functionality to store the video locally on the device, at 075. In some embodiments, the user may be provided with the ability to manage 074 (e.g., CRUD: Create, Read, Update, Delete) the various videos they take for various Client Projects that are local to the user’s device or computer. Further, the user may be provided with the ability upload 076 the video to the Videos / Audio Streaming Servers 012. The third and final option for the Video and Audio functionality in FIG. 5 is Video Option 3 - Real-Time Client (any user) Recording 080. This option will allow the videos on the user’s computer to be managed remotely, at 085. The user’s computer application will be able to send 087 the video remotely, and publish 086 the videos, and delete 088 any and all remaining videos. Both the Video and Audio processing will go hand-in-hand, being handled the same way.

With regard to text communications, various text aspect of the communications between a Client and Service Provider will be stored and communicated from the computer systems for both the Client and Service Provider 001 to the Business Logic Servers 008, as seen on FIG. 2. In some embodiments, these text communications may be stored optimally between various databases 017 and/or file systems associated with the Business Logic Servers 008.

Any time a user (Client or Service Provider) on the present platform communicates regarding a particular project, the other interested users would receive notifications. Step 1301 of FIG. 7C, which expands step 1102 of FIG. 7A, illustrates embodiments where a user communicates on the platform the other interested users will receive a notification regarding the activity.

Continuing down FIG. 7C, once a Service Provider starts to communicate with a Client on the present platform to learn more about an interesting project, they will have the option or decision to continue engaging with the Client about this Client’s particular project. This is noted in step 1303 of FIG. 7C. If the Service Provider decides to continue with the Client via the present platform, at step 1306, processing may proceed to FIG. 7D. If the Service Provider decides after the communications with the Client that they are no longer interested in this Client’s particular project, they will have the option to exit the process, at step 1302

The Service Provider will now have an opportunity to provide an estimate to the Client about their project, such as via the exemplary process set forth in FIG. 7D.

Here, for example, the Service Provider may now estimate the cost and schedule for the project. The first step in this process is represented by step 1400. In some embodiments, the Service Provider may be provided with options to provide the cost of the estimate in either total cost or a time and material approach. Further, the Service Provider may be provided functionality to provide the Client with multiple or a single date and time option(s) for when both the Service Provider and Client can meet at the project’s site location, at step 1401. Once the Service Provider decides the Estimate is correct, the Service Provider will then send the Estimate to the Client, at step 1402.

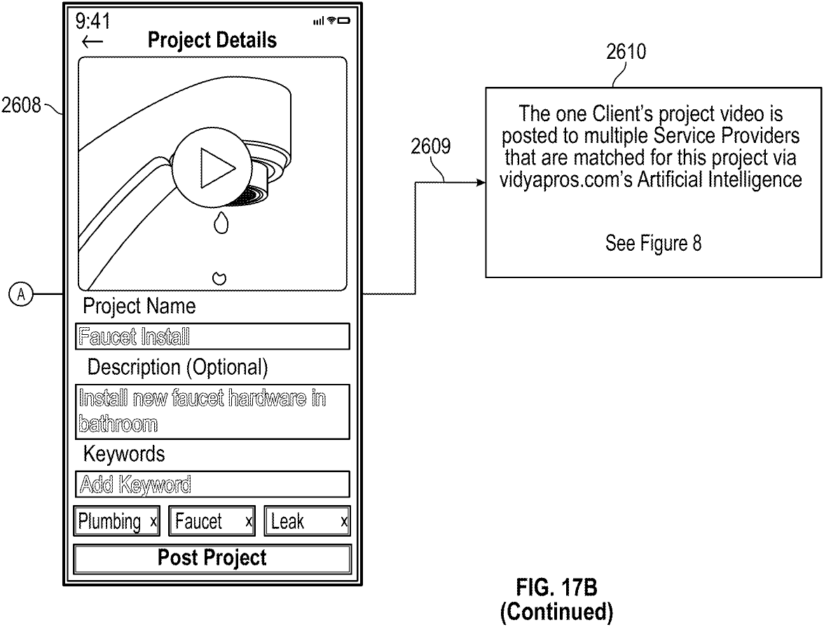

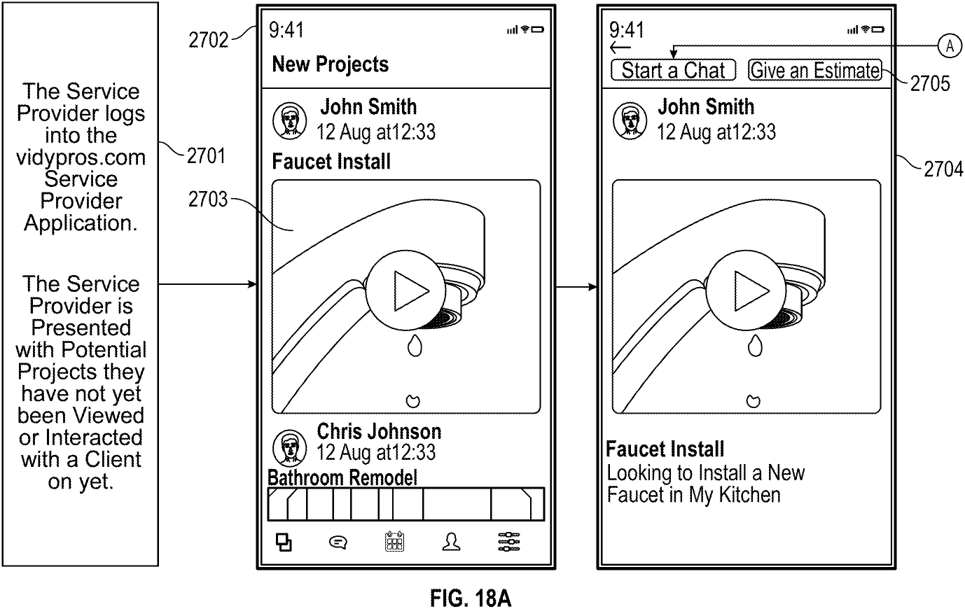

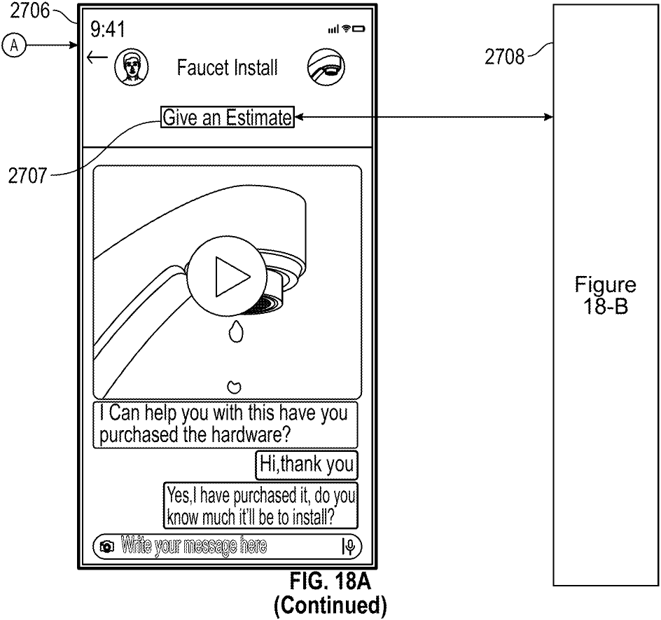

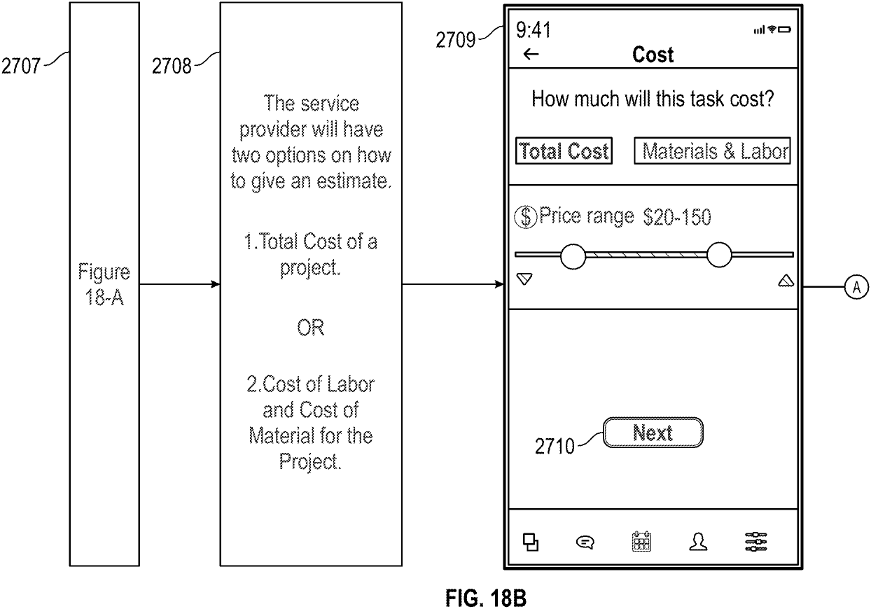

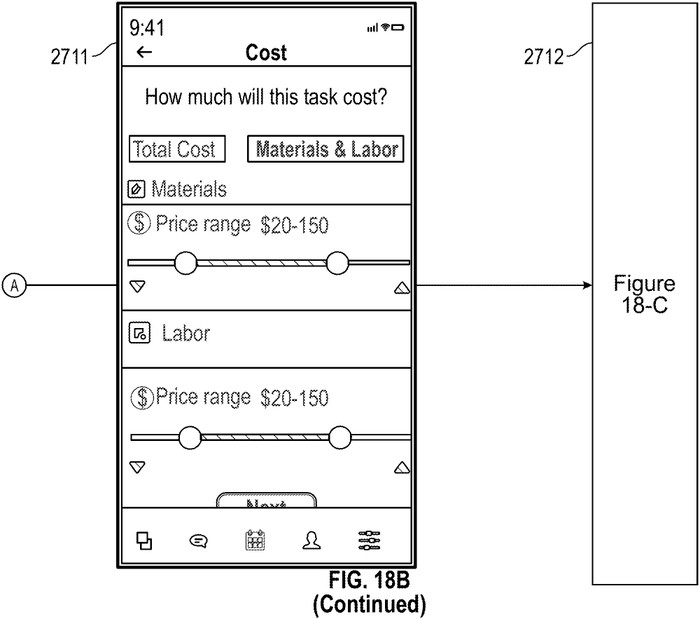

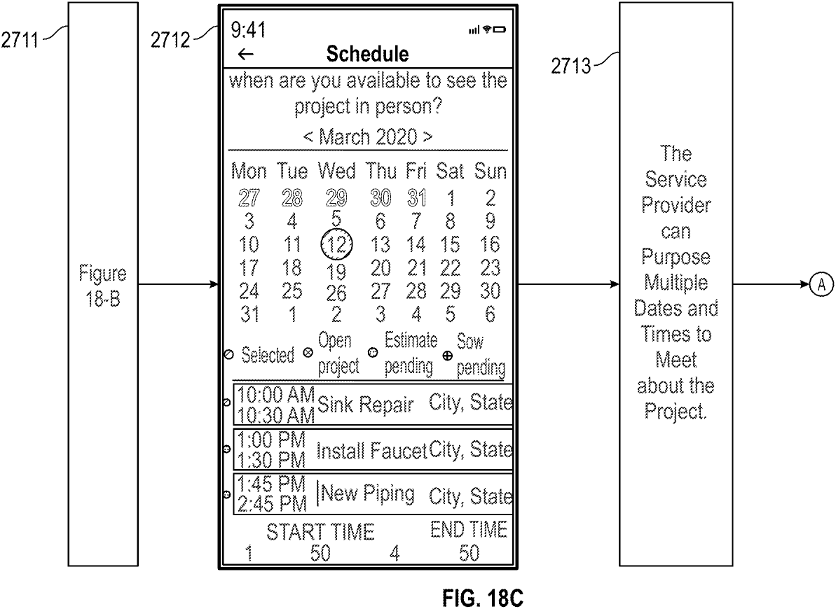

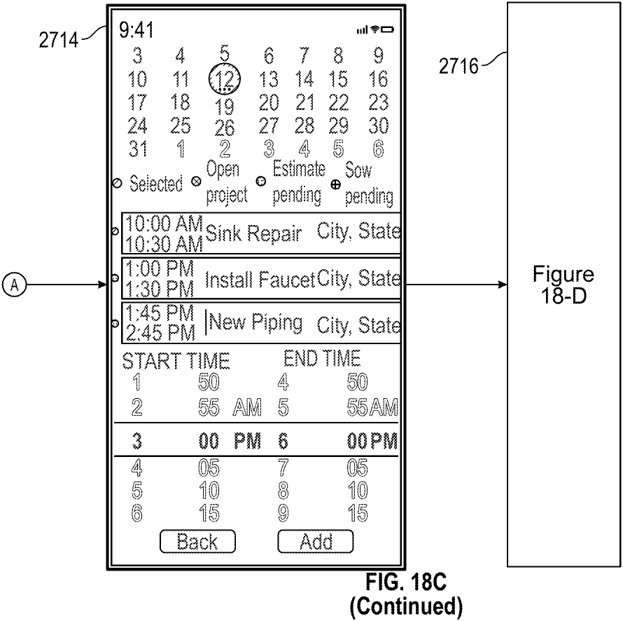

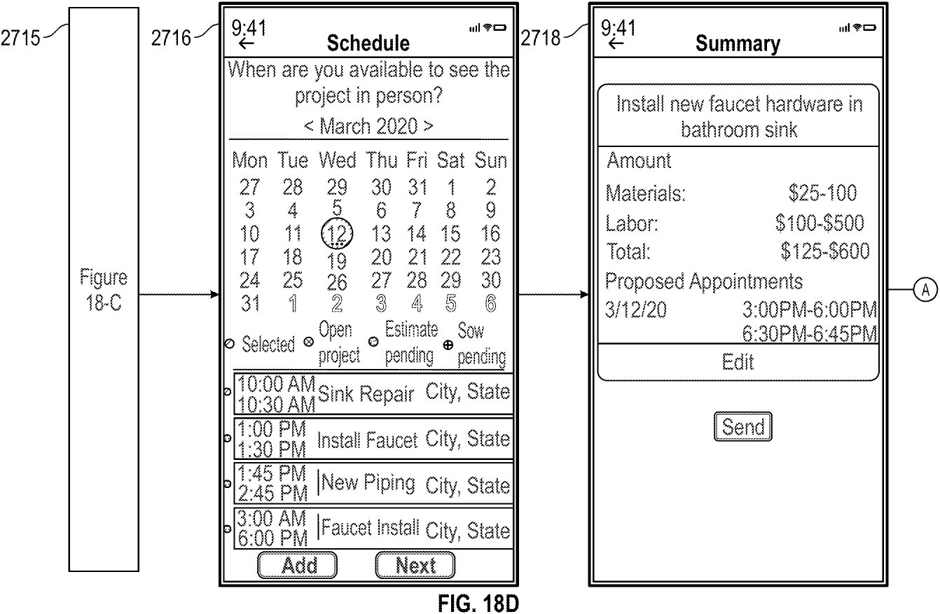

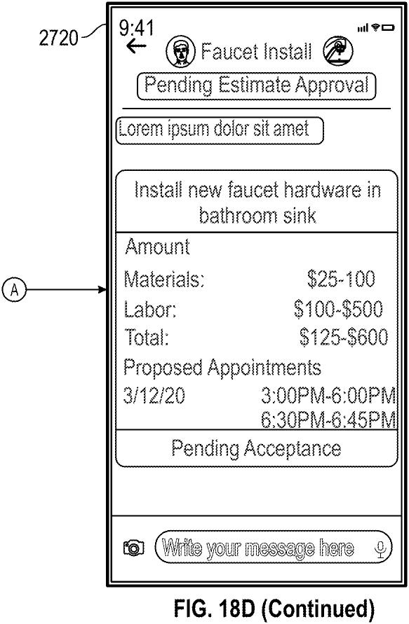

FIGS. 18A-18D, described in more detail below, illustrate a series of exemplary user interfaces including features and functionality associated with a service provider interacting with the exemplary video-driven service platform, e.g., for sending a project’s estimate of resources and time to the client, consistent with various embodiments of the present disclosure.

Turning back to FIG. 7D, step 1403 represents the notification that is sent to the Client once the Service Provider has sent their estimate for the cost and the timing opportunities to meet at the project’s location, on the present platform. The Client will be notified in one of a few ways on their computer platform that runs the present application. The Notification could come in at the operating system level, or at the application icon level for the operating system, or inside the application itself.

In the exemplary embodiment being described, the Client has now received an estimate from one or many Service Providers that are interested in the Client’s project. This is noted in step 1404 of FIG. 7D. Here, in this exemplary process, the Client will need to make a decision if they would like to proceed with the Estimate from the Service Provider and meet the Service Provider at the project’s location. This is noted with step 1405. If the Client decides not to continue with the Service Provider that has given the Estimate, then the Client rejects the Estimate from the Service Provider, at step 1406. The Service Provider will be notified about the Client’s decisions to pursue the project’s resolution with another Service Provider, at 1407. For the Service Provider that the Client has accepted their Estimate for, the Client accepts one of the proposed times to meet at the project’s location, at 1408. The Service Provider will be notified of the Client’s acceptance to meet at the project’s location, at 1409. The next steps for both the Client and the Service Provider are defined in at 1410.

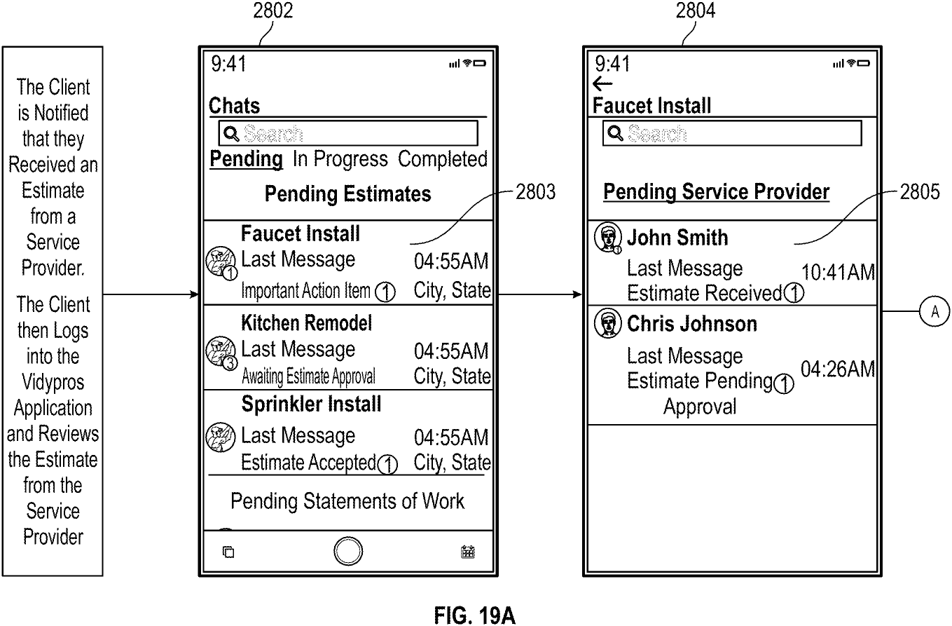

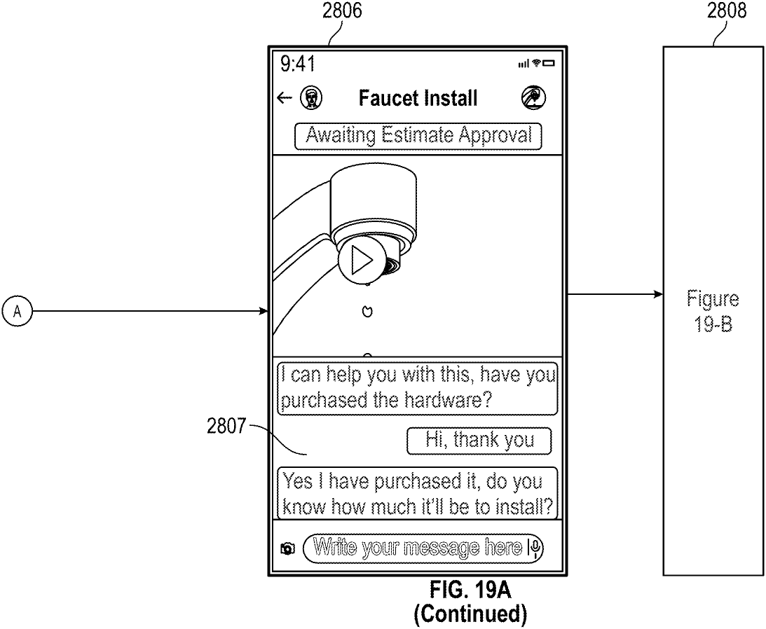

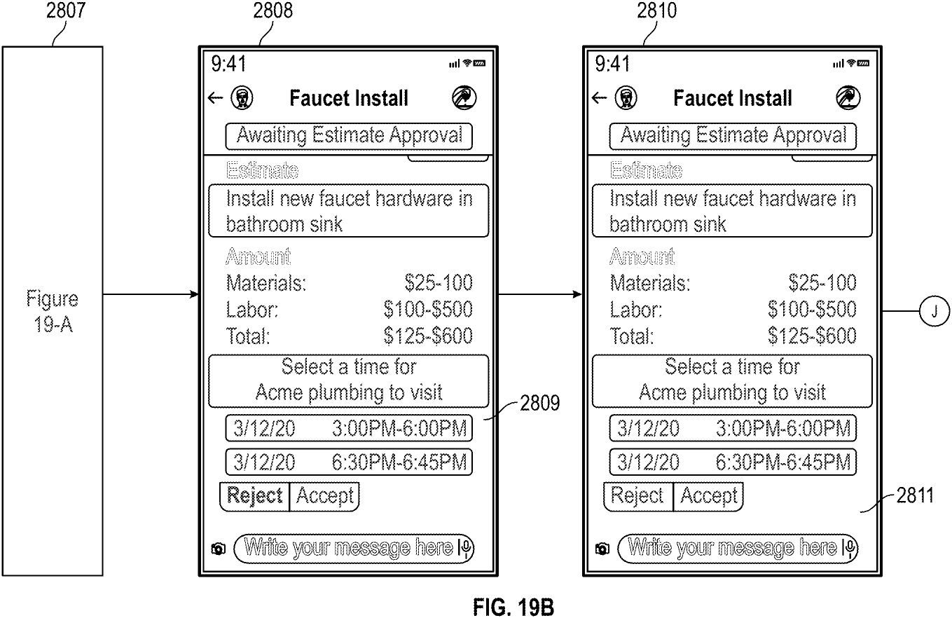

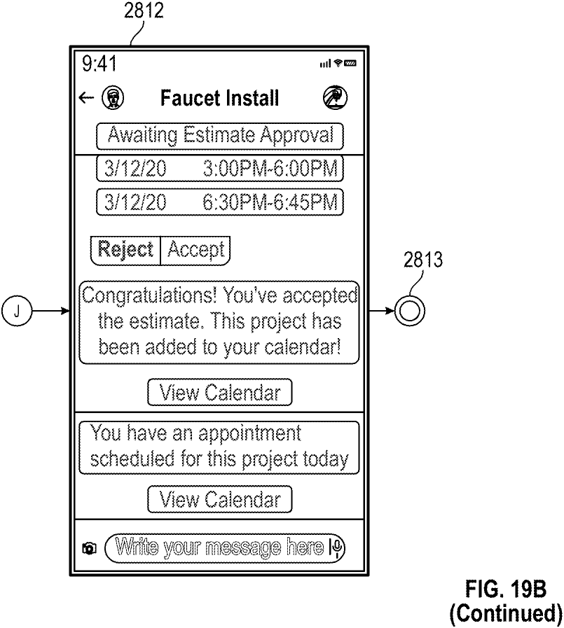

FIGS. 19A-19B described in more detail below, illustrate a series of exemplary user interfaces, features and functionality for a client to interact with the exemplary video-driven service platform in the way of accepting a service provider’s estimate of resources and time for the client’s project, consistent with various embodiments of the present disclosure.

Turning back to FIG. 7E, which illustrating details of step 1104 of FIG. 7A, the exemplary flow of FIG. 7E begins with the Client and the Service Provider meeting at the project’s location, at 1500. The Client and the Service Provider may converse more about the project and visually inspect the project’s details, conditions, and discuss future needed efforts, at 1501. After the variety of discussions by the Client and the Service Provider, the Service Provider makes a decision whether they would like to offer the Client a Statement of Work (SOW) to propose detailed efforts needed to complete the project, at 1502. If the Service Provider decides not to offer the Client a SOW, such decision of the Service Provider to opt-out of the project is shown at step 1503. The Client will be notified about the Service Providers’ decision to not be involved anymore with the Client’s project, at 1512. This notification for the Client can be received at the Operating System level, the App Icon level, or if the Client is in the present application when the notification is received, the Client may be notified within the application itself.

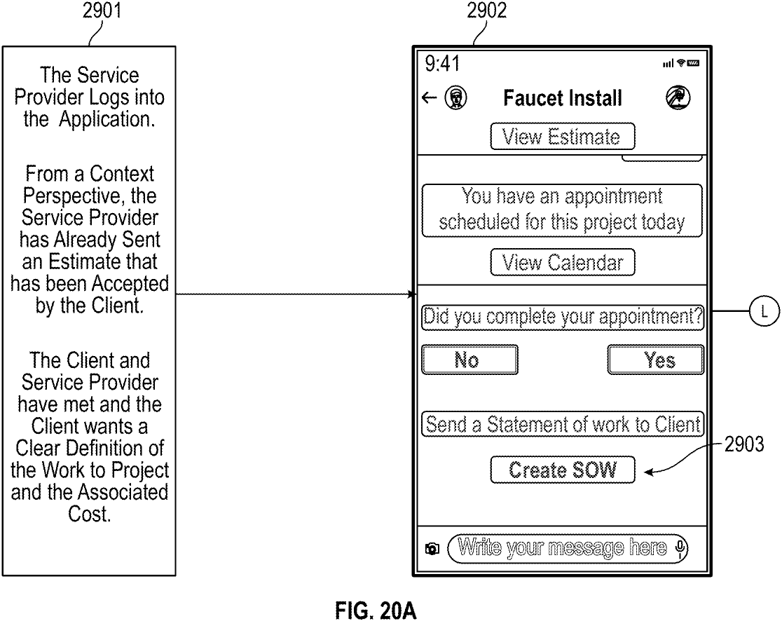

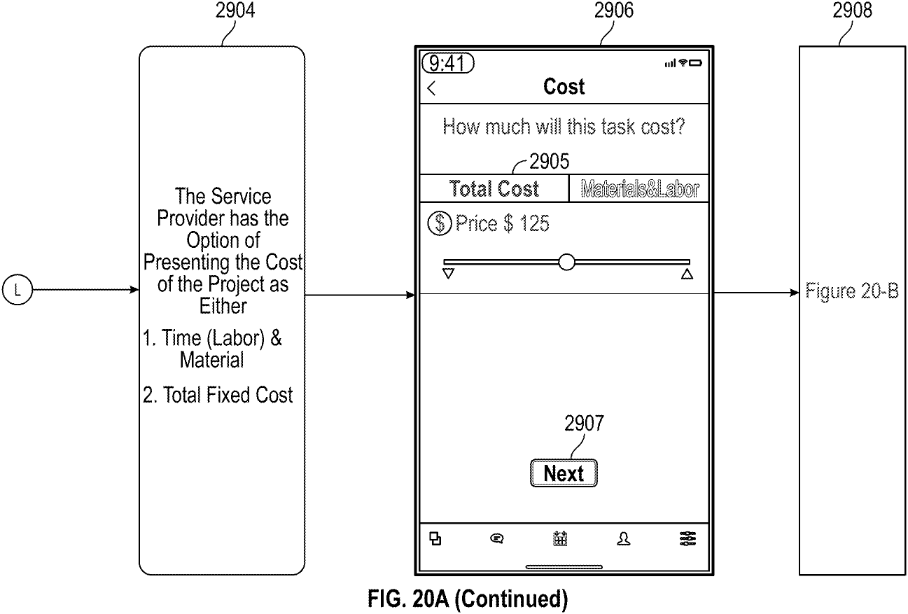

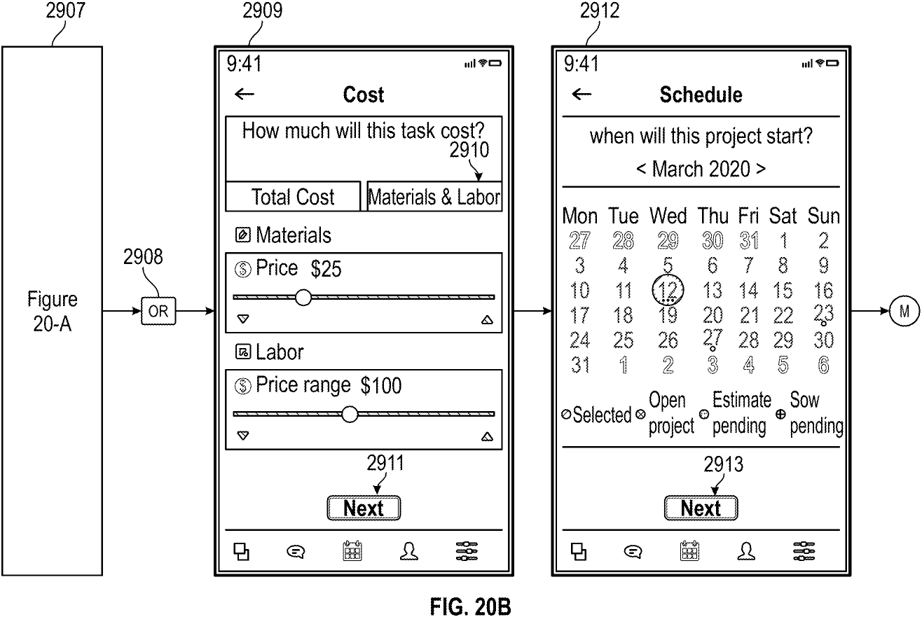

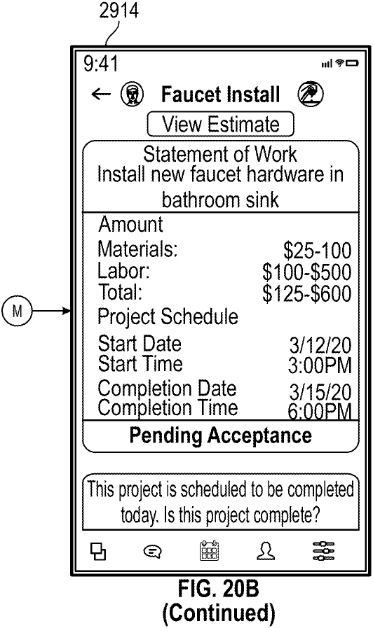

The Service Provider may also elect to proceed with the project, e.g., by sending a statement of work (SOW). Here, with regard to features associated with sending such SOW, FIGS. 20A-20B, described in more detail below, illustrate a series of exemplary user interfaces, features and functionality for a service provider to interact with the exemplary video-driven service platform for sending the SOW to the client, consistent with various embodiments of the present disclosure.

Continuing on, at step 1504 of FIG. 7E, the Client user will receive a notification about the pending Statement of Work from the selected Service Provider. This notification can come in the form of an Operating System notification, an App Icon notification, or an in-App notification associated with the present platform or service. The Client will then select the specific SOW to review, at 1505.

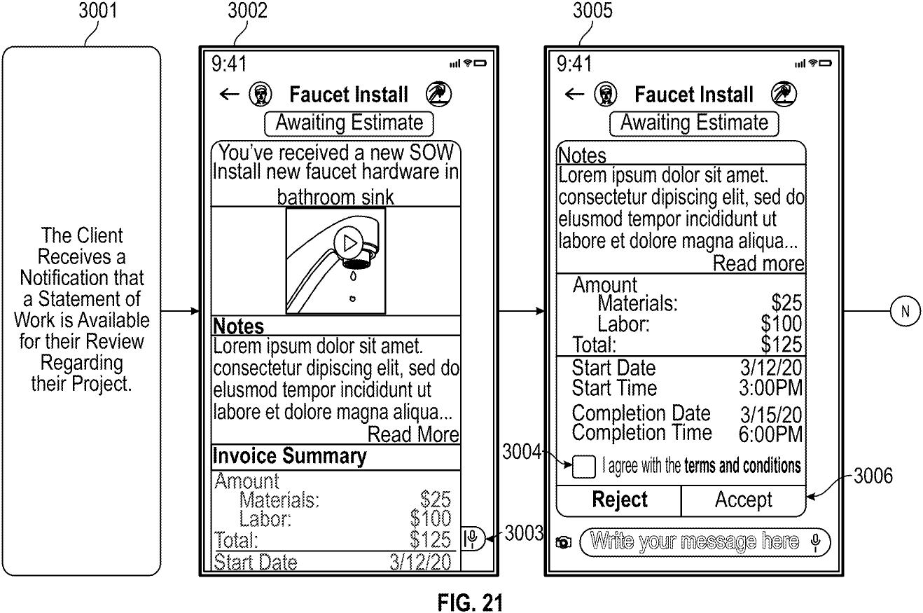

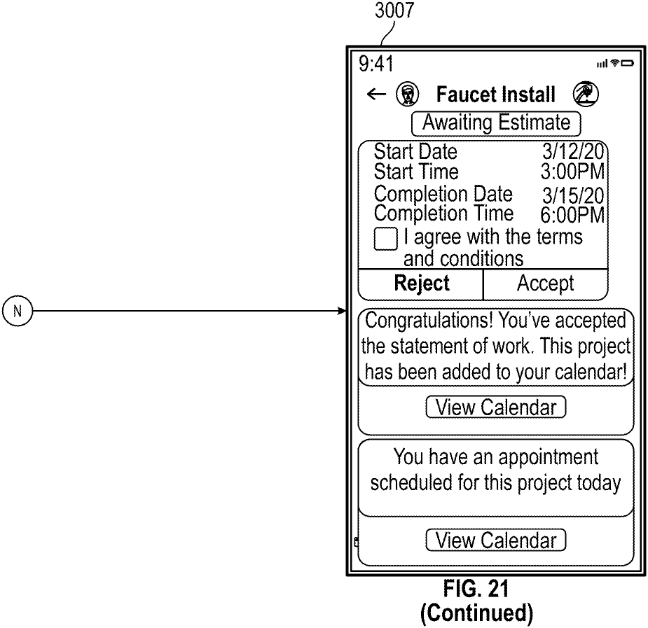

FIG. 21, described in more detail below, illustrates a series of exemplary user interfaces, features and functionality for a client to interact with the exemplary video-driven service platform in the way that the client approves of the project’s statement of work that is provided by the service provider, consistent with various embodiments of the present disclosure.

Referring back to FIG. 7E, at step 1505, the Client reviews the SOW from the selected Service Provider. The Client will now have to make a decision if they want to continue with this Service Provider after reviewing the SOW, at 1506. If the Client does not want to continue with this Service Provider’s SOW, at 1507, the Service Provider will be notified, at 1508. Again, this notification can also come in the form of an Operating System notification, an App Icon notification, or an in-App notification associated with the present platform or service. The Client could potentially want more projects added, at 1513, and then will be taken back to step 1501 to discuss the additions to create more SOWs. The Client will then allow the Service Provider to begin to work on the project, at 1509. The Service Provider then begins to work on the project, at 1510. The next step in the process, step 1511, is also shown in an expanded manner in FIG. 7F, illustrating original step 1105 in even greater detail.

FIG. 7F illustrates an exemplary process after the Service Provider has performed the work for the Client. In this example, the process starts with step 1600, where the service provider finishes the project’s work. The Service Provider may use the present platform to communicate with the Client. In some embodiments, at the next step 1602, the Client will receive a notification that their project is completed successfully based on the agreed Statement of Work (SOW) between the Service Provider and the Client. This notification may come in a variety of forms and/or formats, such as an Operating System notification, an App Icon notification, or an in-App notification associated with the present platform or service. Upon being notified, the Client will then decide, at 1603, if the project is indeed completed according to the SOW. If there is not an agreement, then the Service Provider will need to decide whether they want to continue on the Client’s project and resolve any disagreements with the Client, at 1601. If the Service Provider decides to continue to resolve the disagreement by working on the Client’s project more, the process goes back to step 1509 of FIG. 7E. If the Service Provider cannot resolve their disagreement, then the project’s state stays unfinished, at 1605. When the Client agrees that the project is completed according to the SOW, shown at step 1604, the present system may record the project status change, at 1606, and the project itself may be rated according to its’ performance, e.g., via the present platform, users thereof, or third parties. The project may then be lodged as completed, at 1607. In some embodiments, the Client and the Service Provider may then also be provided with features and functionality to rate various aspects of the project. This rating can be done, e.g. at 1608 and/or 1609, via the various forms of communication for the platform, such as video, audio, text, etc.

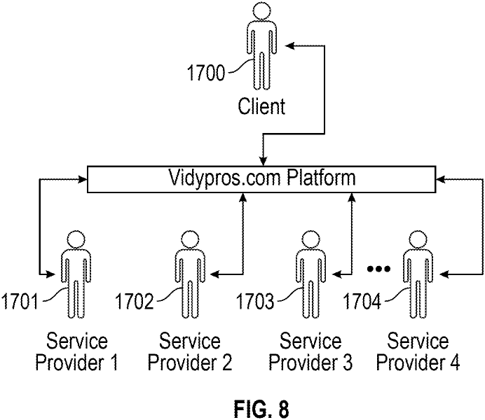

FIG. 8 is a diagram illustrating one exemplary system related to a single client having the possibility to access multiple service providers to receive audio, video, text, social media, messaging, etc. communications regarding the client’s project, consistent with exemplary aspects of certain embodiments of the present disclosure. In FIG. 8, Client’s Access to Multiple Service Providers indicates this approach to send one Client’s project to multiple Service Providers. As shown in FIG. 8, the Client 1700 may interact with multiple Service Providers on the illustrative platform. As is indicated, there can be any number of Service Providers on the illustrative platform that could be matched through artificial intelligence with the Client. These multiple Service Providers are indicated by callout 1701, 1702, 1703, and 1704.

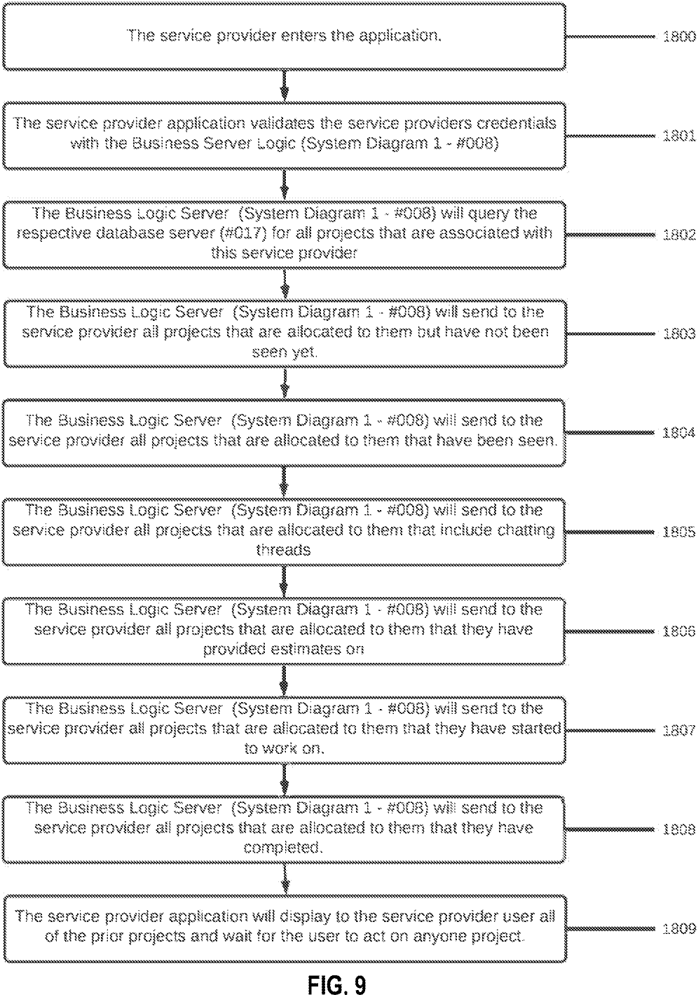

FIG. 9 is a flowchart illustrating one exemplary process related to the service provider’s project dashboard and how the dashboard is built and displayed to the service provider, consistent with exemplary aspects of certain embodiments of the present disclosure.

In FIG. 9, an exemplary sequence of steps associated with a service provider dashboard (steps 1800 through 1809) is shown to illustrate from a server and data perspective regarding build of an initial service provider dashboard. At the start of FIG. 9, step 1800 indicates that a Service Provider runs or executes, and thereby enters, the application. At step 1801, the Service Provider’s user credentials may be checked by communicating with the Business Logic Servers 008 (FIG. 2 - Overall System Architecture). At 1802, the Business Logic Databases 017 will be queried regarding the Service Provider’s user credentials. As shown in FIG. 2, the entire communication path 005, between the Service Provider 001, the Business Logic Servers 008, and the Business Logic Databases 017, all function with a secure and encrypted channel or path which is represented by the security layer 004. During this process of retrieving all the data associated with the Service Provider’s dashboard, in some embodiments, one or more of the following are the attributes retrieved, at 1802: projects associated with this Service Provider, at 1803; projects that will be sent to the service provider but have not seen by the Service Provider yet, at 1804, projects that have been already seen by the Service Provider, at 1805, projects that the Service Provider has participated in chatting threads, at 1806, projects the Service Provider has given estimates on, at 1807, projects that the Service Provider has started to work on, at 1808, and projects completed by the Service Provider. Once all this data is delivered to the Service Provider’s application, this data may be displayed, at 1809, for the user to interact with.

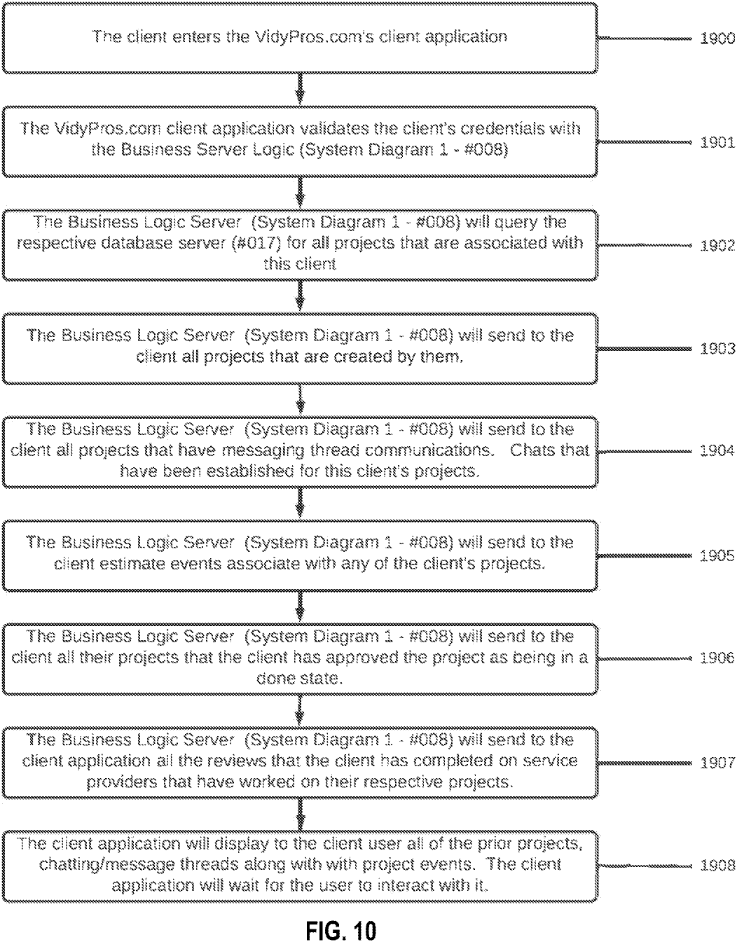

FIG. 10 is a flowchart illustrating one exemplary process related to the client’s project dashboard and how the dashboard is built and displayed to the client, consistent with exemplary aspects of certain embodiments of the present disclosure. In some embodiments, such Client Dashboard may be built for the Client user. FIG. 10 illustrates various steps, steps 1900 through 1908, that may be taken in connection providing and performing processing associated with a Client Dashboard, including details regarding data and/or server features that contribute to building the Client user’s dashboard. In the exemplary embodiment shown, the Client user will log into their application, at 1900, and then, at 1901, the Client’s user credentials may be checked by communicating with the Business Logic Servers 008 (FIG. 2 - Overall System Architecture). Further, in some embodiments, the Business Logic Databases 017 may be queried regarding the Client’s user credentials. In some embodiments, in some or all of the communication path 005, between the Client 001, the Business Logic Servers 008, and the Business Logic Databases 017, communications and/or functionality may be implemented via at least one secure and encrypted channel or path which is represented by the security layer 004. Once the Client’s credentials are verified and confirmed, the Client’s dashboard is built by retrieving a variety of projects in various states. In some embodiments, Database 017 contains the data for the Client’s projects. The query into this database may retrieve various types or sets of projects such as: at 1902, all projects that are associated with this client; at 1903, all projects that have been created by this Client; at 1904, projects that have messaging threads associated with them; at 1905, any and all estimate events for this Client; at 1906, all projects the Client has approved; at 1907, all reviews that the Client has completed for projects. Once all this data is delivered to the Client application, the Client application may display all the collected data for the Client, at 1908.

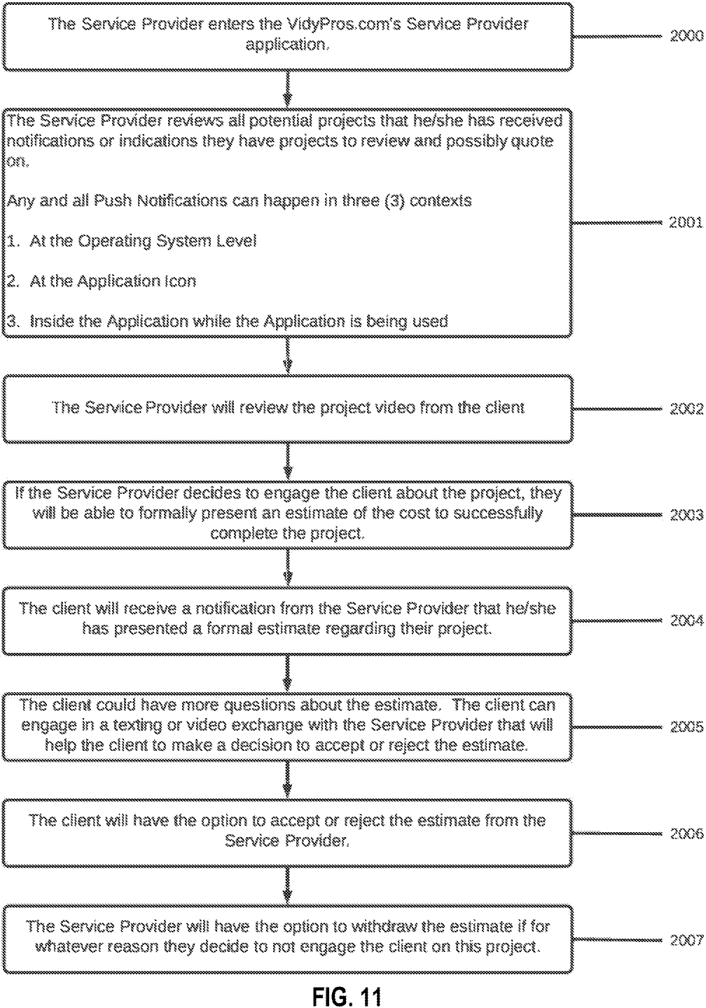

FIG. 11 is a flowchart illustrating one exemplary process related to the service provider creating a project’s estimate of cost and time to complete the client’s project, consistent with exemplary aspects of certain embodiments of the present disclosure. In FIG. 11, a flow of Service Provider’s Estimate process via steps 2000 through 2007 is illustrated at a higher level of the Service Provider’s Estimate operation. The flow starts at 2000, where the Service Provider enters the present application, which can be used to render project estimates by the service provider. At 2001, various kinds of notifications that a Service Provider may process are received. Such notifications can come in the form of an Operating System notification, an App Icon notification, or an in-App notification associated with the present platform or service. At 2002, an important step of the Service Provider’s process, the service provider reviews the project video from the client. In some examples, such review may be accomplished via straightforward video review of a project video that has been assigned to this specific Service Provider, e.g., by Artificial Intelligence, machine learning trained projects coordinator, or a human operator. At step 2003, the present platform allows the Service Provider to quickly and easily engage with the Client, via various messaging channel using text, audio, and video. At 2003, the service provider would also provide an estimate of the cost to the client. At 2004, the platform enables the Client to review the submitted Estimate from the Service Provider. At 2005, when the client has questions about the estimate or would like to negotiate or inquire further, the present platform provides the client with communication via video, audio, text regarding the Client’s project. With the ease to use communication tools on the present platform, the exchange between the client and service provider is facilitated to help the client to make a decision regarding to accept or decline the estimate. At 2006, the present platform allows the Client to easily accept or reject an Estimate from a Service Provider, via various communication channels over text, voice and video. At 2007, the present platform also provides flexibility for the Service Provider to exit out of the engagement with the Client and their project.

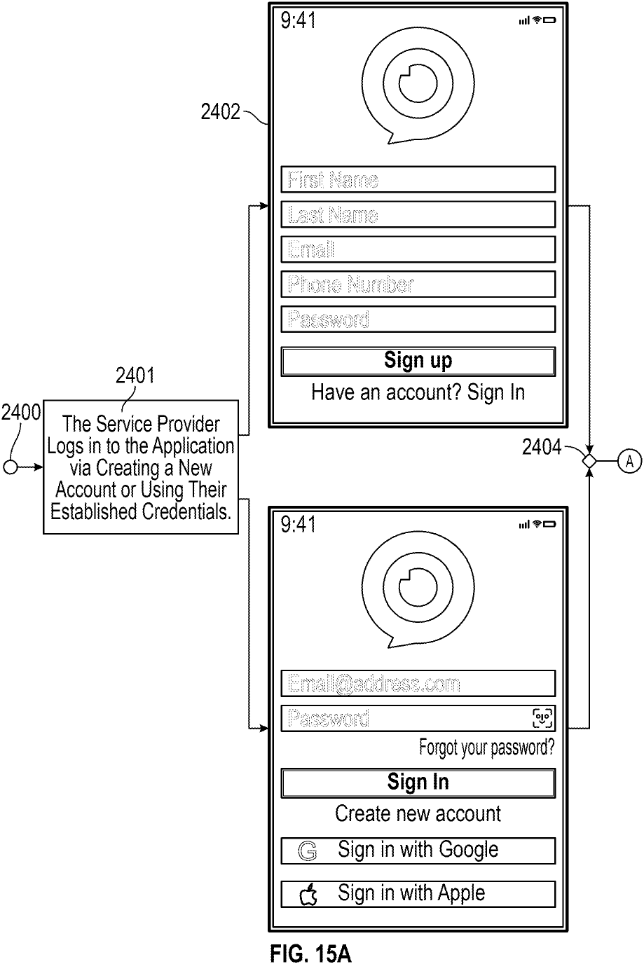

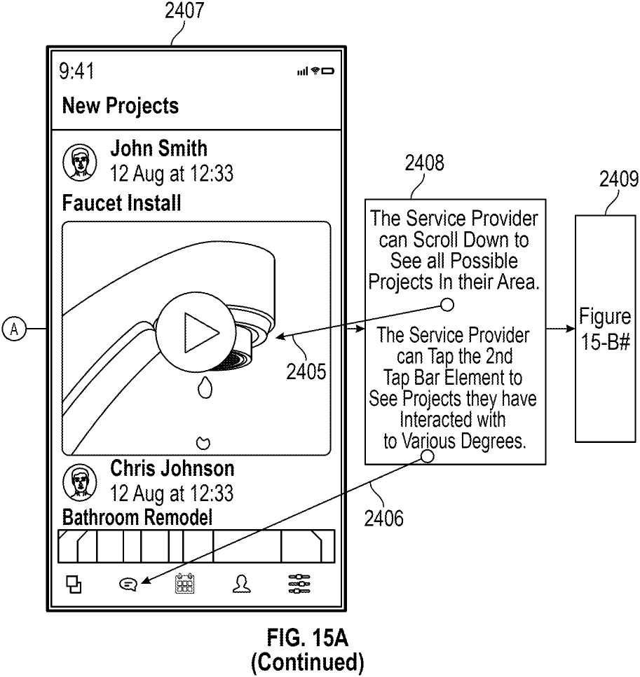

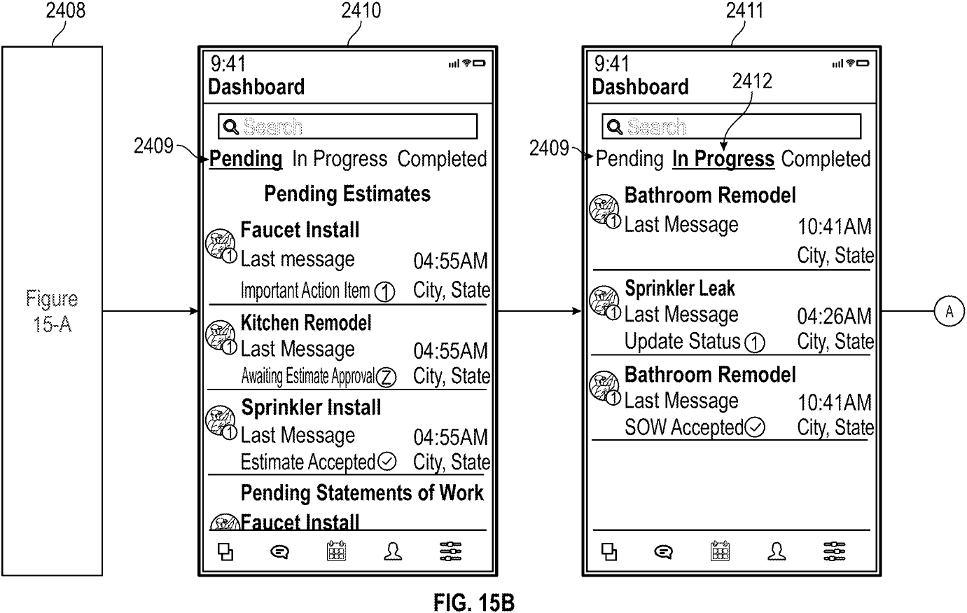

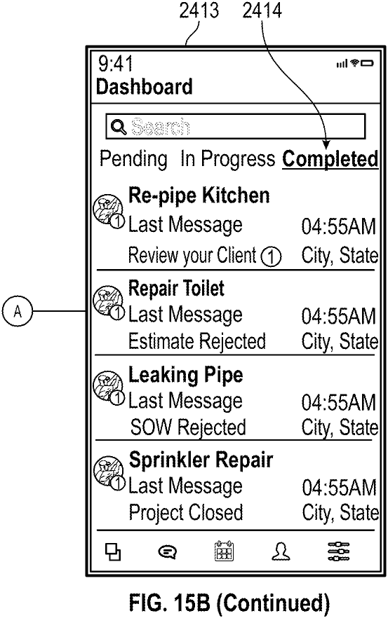

With regard to some exemplary Service Provider dashboards and GUIs, FIGS. 15A-15B, described in more detail below, illustrate a series of exemplary user interfaces, features and functionality for a service provider client to interact with the exemplary video-driven service platform, consistent with various embodiments of the present disclosure.

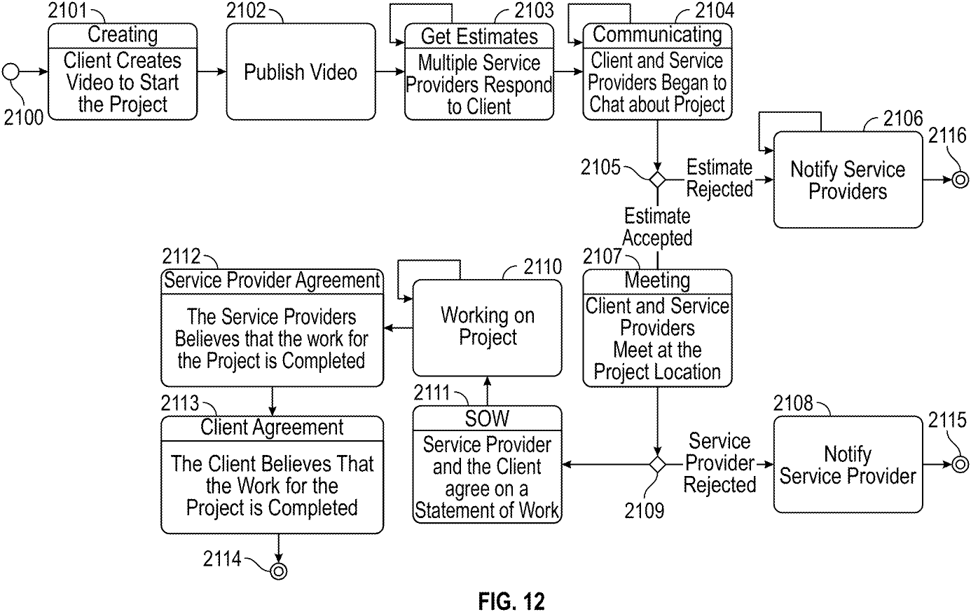

Referring now to FIG. 12, FIG. 12 is a flow diagram illustrating one exemplary process related to a client’s project and the various states that the project could be in is shown, consistent with exemplary aspects of certain embodiments of the present disclosure. In FIG. 12, a Project’s State or Activity Diagram (e.g., callout 2100 through callout 2116) is illustrated along with the flow. In various embodiments, a Client’s project can go through a variety of states. FIG. 12 diagrams the flow and various states of a Client’s project. In some embodiments, the Client’s project starts off in a “Creating” state 2101, at which The Client will create a new project. In some embodiments, the mechanism for creating the project for a client is taking a video of the project and publishing the video, at 2102. The Project then transitions into a state of “Get Estimates” 2103, in which the platform allows a multitude of Service Providers to send in estimates for a variety of projects. As these estimates are in the process of being gathered, there could be a variety of communications happening, so the project could be in “Communicating” state 2104. Once the communication and getting estimates stages are done, then the project can be transitioning into a “Meeting” state 2107, and/or into “Notify Service Providers” state 2106 for estimates that were not accepted. Once past state 2106 of “Notify Service Providers,” that aspect of the project for those Service Providers has ended, at 2116. Once the Client and Service Provider meet to discuss in more detail at the project site, in some embodiments, the project can either transition into a “Notify Service Provider” state 2108, if the Client decides not to go forward with that Service Provider. Alternatively, and in some embodiments, the project goes into an “SOW” state 2111, when the Service Provider will provide a statement of work (SOW) for the project. If a Service Provider is rejected, then the state of the project for that Service Provider reaches the endpoint, callout 2115. Once the SOW is provided and agreed upon, then the project will transition into a “Working on the Project” state, callout 2110. Once the work is done then the final two states, service provider agreement state 2112 and client agreement state 2113, both for working to bring agreement from the Service Provider and the Client that the SOW criteria has been met. Finally, at 2114, the project is in a done state. Further, the project’s state activity has a couple of branching points 2105 and 2109, which lead to ending the project from the Service Provider’s perspectives.

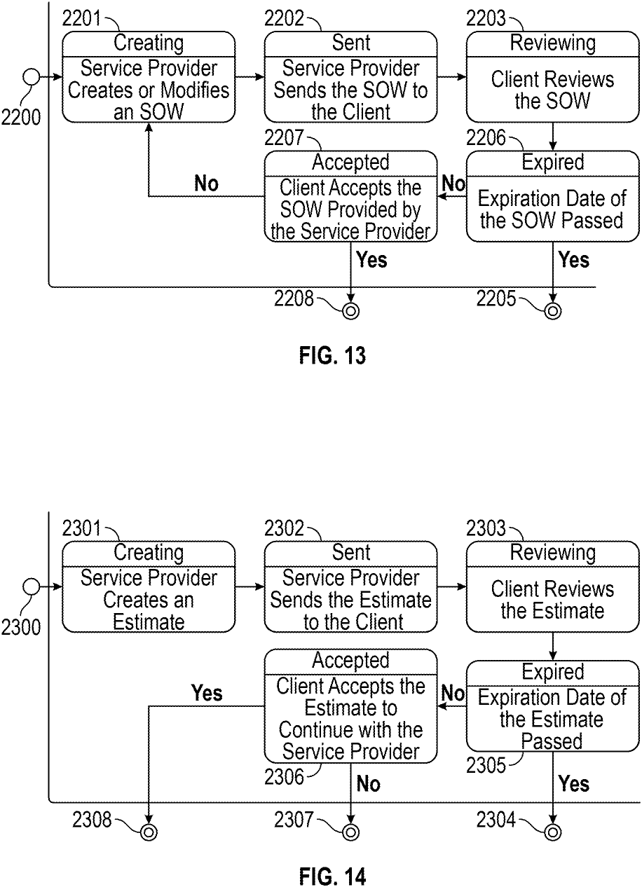

FIG. 13 is a flow diagram illustrating one exemplary process related to a project’s statement of work (SOW) and the various states the SOW might be assigned in some implementations, consistent with exemplary aspects of certain embodiments of the present disclosure. In FIG. 13, a State / Activity Diagram for the Statement of Work (SOW) is shown. Starting at 2200, the first state of the SOW is “Creating” 2201. Next, the SOW progresses to the next state of “Sent” 2202, which basically indicates that the Service Provider has sent the SOW to the Client for their review. When the Client is reviewing the SOW, the flow transitions into the state of “Reviewing” 2203. In some embodiments, the next potential state is “Expired” 2206. When a Service Provider creates an SOW, there is a time limit for the SOW, it can be active during a time window or expire post the time window. In some embodiments, the default state is active. If the SOW has indeed expired, then the SOW has reached its’ end state 2205. In other embodiments, the next possible state for the SOW is state “Accepted” 2207. At this state, the Client has accepted and agrees with the Service Providers “SOW”. If the Client does not agree with the SOW, then the Service Provider will need to modify or create a new SOW. In this case, the state is transitioning from the state 2207 to the creating state 2201. Finally, the endpoint for the SOW is, when Client agrees the SOW has been accepted, the state 2208.

FIG. 14 is a flowchart illustrating one exemplary process related to the various states that a service provider’s estimate for a client’s project could be in, consistent with exemplary aspects of certain embodiments of the present disclosure. In FIG. 14, an Estimate’s State / Activity Diagram is shown to illustrate the various states that an estimate can be in. The starting point for FIG. 14 is at step 2300, after which an initial state for an estimate is entered into to the “Creating” 2301. At this state, the estimate is being created by the Service Provider for the Client’s review for either acceptance or rejection. The next state for the estimate is the “Sent” state 2302, at which the Service Provider has sent the estimate to the Client for their review. The next state of the estimate is “Reviewing” state 2303, at which the Client is reviewing what the Service Provider has sent to the Client. In some embodiments, the state of the estimate is always checked for timing so that the estimate could transition into a state of “Expired” 2305. If the estimate transitions into that state of “Expired” 2305, then the Estimate’s endpoint is reached at 2304. The next state for the Estimate is the “Accepted” state 2306, which can be either “No” state 2307, or “Yes” state 2308.

FIGS. 15A-15B illustrate a series of exemplary user interfaces and associated features and functionality associated with a service provider interacting with the exemplary video-driven service platform, in accordance with certain embodiments of the present disclosure. As shown herein, after login 2401, FIG. 15A depicts an example sign-up screen 2402 that may comprise a plurality of UI fields for the service provider client to enter the information required for signing with the service provide at the platform. For example and as shown herein, the sign-up screen 2402 may include a plurality of text fields (e.g., text) for the service provider client to enter a first name, last name, email address, phone number, password for association with a new service account, as well as a button to sign-up with the afore-described information. Further, FIG. 15A depicts a button to sign in based on the credentials entered, and other related UI options, such as an option to sign with credentials associated with a known or trusted entity such as a google account, an Apple account.

Once signed-in, the platform may transition, at 2404, to present the service provider client with an initial new project screen 2407, which may provide the service provider client with various information regarding the projects serviced by the platform. As shown herein, FIG. 15A displays a list of new projects opening for bids at screen 2407, and the service provider client may scroll down 2405 the list to view and access detailed information associated with the projects. In various embodiments, project information may be presented in any suitable manner. In this example, screen 2407 displays a customer’s name, posting date, and a video clip for each projects. In other examples, the platform may provide clients with options to configure the displaying information related to various projects.

FIGS. 15A-15B further display various exemplary features, functionality and/or commands for the service provider client to navigate from the initial screen 2407 to other user interfaces. In the illustrative embodiments shown, for example, the service provider client may select an icon/tab to navigate 2406 from the initial screen 2407 to a dashboard screen 2410, 2411, and 2413 as shown herein FIG. 15B. Here, as indicated by the “pending” tab 2409, dashboard screen 2410 displays a list of pending estimates submitted by the service provider client with the platform at the point of time. An estimate entry of the list displays information such as the project name, the time when the estimate was submitted or updates, and the like. In this example, statuses of the pending estimates are also displayed in color-coded scheme to provide the service provider client with an easy to comprehend glance thereof.

In the example embodiment of FIG. 15B, dashboard screen 2411 displays a list of projects in progress by the service provider for the client at the point of time, as indicated by “in-progress” tab 2412. An entry of the list displays information about the undergoing projects, such as the project name, the time of the last update, and the like. In this example, statuses of these projects are also displayed in color-coded scheme to provide the service provider client with an easy to comprehend glance thereof. Also as shown herein, screen 2411 is further configured to provide the service provider client with a search box at the top to allow searches amongst the listed projects.

Dashboard screen 2413 displays a list of projected completed by the service provider for the client via the platform at the point of time, as indicated by “completed” tab 2413. An entry of the list displays information such as the project name, the time when the work was completed, and the like. In this example, statuses of the completed projects are also displayed in color-coded scheme to provide the service provider client with an easy to comprehend glance thereof. For example, the status can include respective color information for the projects deemed complete due to the expiration of estimate bid, or projects serviced by the client to completion. Similarly, screen 2413 is configured to provide a search to allow for searches amongst the listed projects.

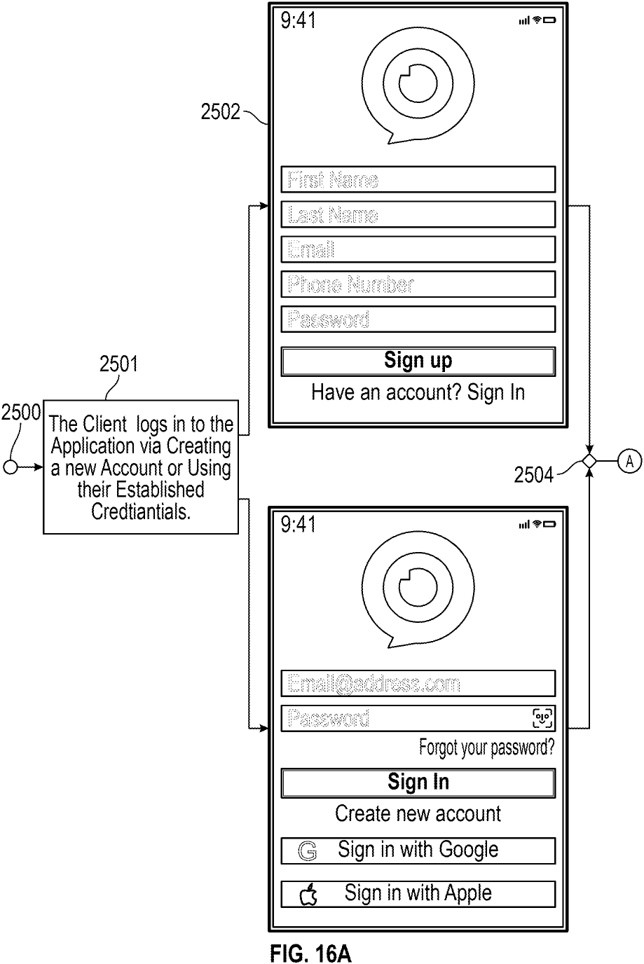

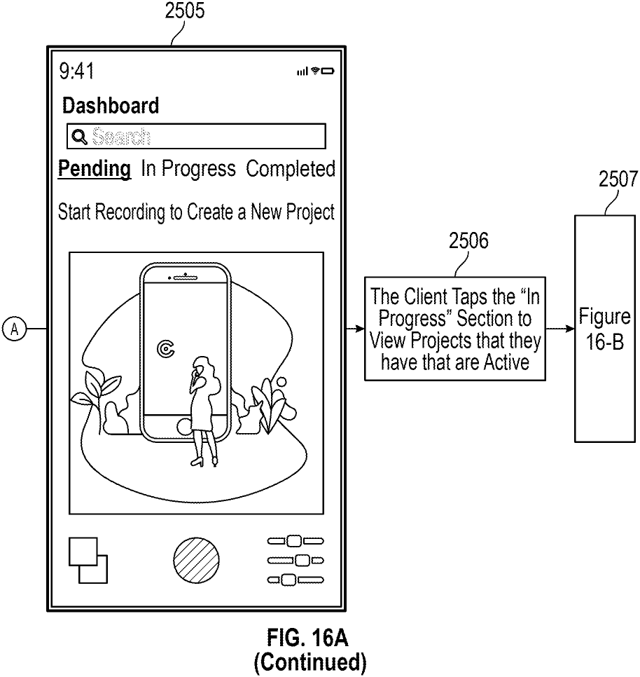

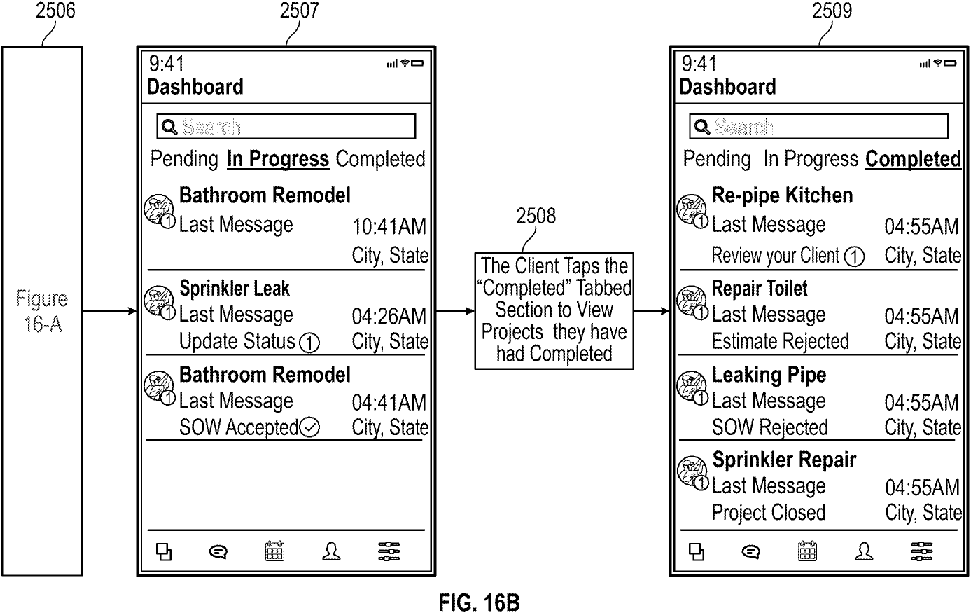

FIGS. 16A-16B are a series of exemplary user interfaces, features and functionality for a client to interact with the exemplary video-driven service platform, in accordance with certain embodiments of the present disclosure.

As explained herein, a Client Dashboard 2505 may generated and presented to provide the example user experience shown in FIGS. 16A-16B, which illustrate features and functionality of an exemplary client dashboard. At the starting point 2500, the client is to access the Client’s dashboard. The Client next logs-in to the application, at 2501. The Client user may be presented with various ways to enter the application. In some embodiments, initially, the client could create an account on the present platform or could log in if they have established credentials, via screen 2502, which includes respective data fields 2503 and 2504 for entering the username and password using the sing in button, or choose to sign in with google or apple. According to the illustrated embodiments, once logged in, at 2504, to the Client dashboard 2505, the Client user may be displayed a GUI with various functionality, such as one or more of the three tabbed sections shown and described herein: 1 - Pending, 2 - In Progress, and 3 - Completed. Here, the initial screen 2505 shows with the pending tab active as the default tab, with the screen 2505 informing the user to start record videos to create new projects as well. The Client user will be able to tap on any one of the three to see their projects that qualify for their various states. The Client user will notice the consistent red camera button on the dashboard. This allows the Client user to easily create any new projects. Once the user taps the in progress tab at 2506, a screen 2507 is displayed to show the projects in progress. Once the user taps the complete tab at 2508, a screen 2509 is displayed to show the projects completed.

FIGS. 17A-17B are a series of exemplary user interfaces, features and functionality for a client to interact with the exemplary video-driven service platform in the form of creating the client’s project that service providers could possibly provide an estimate of resources and time to complete the client’s project, in accordance with certain embodiments of the present disclosure.

In FIGS. 17A-B, various network interactions are illustrated from the Client’s perspective in using the present application. In the start, at 2600, the Client begins a project. In some embodiments, to do so, the Client will have to log into the present application 2601 on one of the computer platforms supported to access the dashboard page 2602. In some embodiments, the application could possibly keep the user logged in. On dashboard page 2602, there is a large red button 2603 on the bottom of the screen 2602. This red button 2603 will easily allow the Client user to start a project by bringing up the camera on the computer platform to record the project and its needs. The Client user will press the red button 2605 to record the project on screen 2604. Once the Client user is done with the recording of the project and speaking to its needs in the video, the Client user will have the option to modify the video’s length and/or content on screen 2606. The Client user proceeds on by pressing the Save button 2607. In some embodiments, the Client user is then taken to screen 2608 that allows the user to modify or enter a variety of attributes for the project. Once the Client user is satisfied that the project is ready to be sent to the potential Service Providers, the Client user can press the Post Project button 2609 to start the process of uploading the video for this new project to the present platform. In box 2610 it is indicated that once the video is available for the Service Providers to review, the particular project’s video will be available for a multitude of Service Providers. In some embodiments, the project is made available or matched to service providers via AI on the present platform.

FIGS. 18A-18D are a series of exemplary user interfaces, features and functionality for a service provider to interact with the exemplary video-driven service platform for sending a project’s estimate of resources and time to complete to the client, in accordance with certain embodiments of the present disclosure.

In FIGS. 18A-18D, various exemplary aspects and interactions of the Service Provider creating the estimate for the Client’s project on the platform are shown. Beginning at step 2700 in FIG. 18A, the Service Provider will log into the application on their computer platform, at 2701. Next, in the presently illustrated embodiment, the Service Provider is presented with many projects they can review, at page 2702. When a Client has sent out a video for a new project, that project will show in this list on page 2702. When the service provider see a video that is interesting to them or the Client’s new project, they can press the play button 2703 for that particular video of a project. Since the Service Provider will receive a notification about the Client’s new project, they will head directly to screen 2704 when they respond to the notification. Either way upon getting to screen 2704, the Service Provider will have the option of communicating directly with the Client who created the video and project, via start a chat button. Once the communication is done on screen, on page 2706 and the Service Provider feels comfortable providing an estimate for the project, the Service Provider can press the button Give an Estimate 2707. Upon making such selection, the Service Provider will be taken to screen 2709, which will allow the Service Provider to provide an estimate for the project by either providing a total cost of the project or a way to enter time and material cost for the project. The two different estimate types are described in box 2708 and shown on screens 2709 and 2711. Once the cost estimate is determined for the Client’s project, the Service Provider hits the Next button 2710 to proceed with the screen 2712, that will help the Service Provider offer some scheduling dates and times to meet at the project site. As the Service Provider progresses through screens 2714 and 2716, via buttons 2715 and 2717, multiple or single scheduling options to meet (described in the text 2713) are provided, and the Service Provider will come to screen 2718 that allows the Service Provider to review the estimate that they will be sent to the Client to solve the Client’s project’s needs. The Service Provider can make sure they are comfortable with what they will be sending to the Client. Once the Service Provider is ready to send the Estimate to the Client on-screen 2718, they will press the Send button 2719. Next, the Service Provider will be taken to screen 2720 once the estimate has been sent to the relevant servers herein. The resulting screen of successful communication with the present servers is what screen 2720 represents. The endpoint for the Service Provider sending a Client an Estimate for their particular project is represented at 2721.

FIGS. 19A-19B are a series of exemplary user interfaces, features and functionality for a client to interact with the exemplary video-driven service platform in the way of accepting a service provider’s estimate of resources and time for the client’s project, in accordance with certain embodiments of the present disclosure. In FIGS. 19A-B, the Client Accepting or rejecting an Estimate via the user interfaces is shown. The entry point for the Client to start to review an estimate is at 2800. It is noted at 2801 that the Client will receive a notification from the present platform’s Notification Server 006 of FIG. 2 (Overall System Architecture). In FIG. 19A, the flow begins at 2801 and continues at 2802, which places the Client user on a screen that shows, according to the illustrated embodiment, one or more of all the Client user’s projects in one of three states. 1 - Pending. 2 - In Progress. 3 - Completed. When the Client user is trying to get a Service Provider to work on their project, the Client user may look in the Pending section which lists all the Projects that the Client user is trying to move forward with a Service Provider. The Client user will select the specific project 2803 that they are wanting to move forward. Once the Client user selects the specific project to move forward, they may be presented with the appropriate screen, at 2804. In some embodiments, this screen 2804 may list all of the communications with the various Service Providers that have worked with the Client user regarding their specific project. In this example, the Client user may then select the one Service Provider 2805 indicated, e.g., to view their Estimate(s). In some embodiments, here, the Client user will transition to screen 2806, and then scroll down 2807 to see the Estimate that was sent by this specific Service Provider. The Client user will see the Estimate in screen 2808. The Client user will accept one of many dates and time options to meet the specific Service Provider at the project’s location, 2809. Once the selection is done, the Client user will see a screen 2810 where the Client user can Accept 2811 that specific estimate from the specific Service Provider. Once the Client user accepts the Estimate and schedule to meet, there will be an indication of Acceptance and an ability to view the Calendar entrees for the Client user’s project, at screen 2812. The Client user flow for accepting an Estimate from a Service Provider ends with step 2813.

FIGS. 20A-20B are a series of exemplary user interfaces including features and functionality associated with a service provider interacting with the exemplary video-driven service platform for sending the statement of work (SOW) to the client, in accordance with certain embodiments of the present disclosure. In FIGS. 20A-B, an exemplary GUI sequence of a Service Provider sending a Statement of Work (SOW) via user interfaces is shown. The starting point for the Service Provider user begins at 2900 in FIG. 20A. According to this illustrated embodiment, the Service Provider may log into the present application or could already be logged into the application. Here, for example, box 2901 gives a summary of the events that may have occurred for the present process to be ready for this next step of creating an SOW for the Client by the Service Provider. At callout 2902 of the communication thread between the Client and the Service Provider, the Service Provider may be presented with the option to provide a SOW for the specific project by this specific Client. Once such selection is made, e.g., via button 2903, the user may then also be presented with options to provide a time and/or material SOW with details or total cost SOW details for the Client, as illustrated via box 2904. In some embodiments, the Service Provider may be provided with options, e.g., option 2905 or 2910, for selecting various types or categories of cost associated with the project, or similar selections or options to provide SOW details. Examples of such functionality may be seen on screen 2906 or screen 2909. Depending on either type of cost option that is presented to the Service Provider, at 2908, the Service Provider will press either the button 2907 or the button 2911 to progress through the process of creating the SOW for the Client. The Service Provider will then select multiple dates or a single date and time to start the project on the SOW on screen 2912. Once the selection of the dates has been completed, the Service Provider will then press the button 2913 to send the SOW to the Client. The Service Provider will then be shown an acknowledgment 2914 of sending the SOW to the Client. The ending of the user experience for the Service Provider sending the Client an SOW is at 2915.

FIG. 21 is a series of exemplary user interfaces including features and functionality associated with a client interacting with the exemplary video-driven service platform in the way that the client approves of the project’s statement of work that is provided by the service provider, in accordance with certain embodiments of the present disclosure. FIG. 21 shows the interfaces used by the Client Approving the Statement of Work (SOW) to accept the recently delivered SOW from the chosen Service Provider. A starting point for this user experience is at 3000. At box 3001, a notification or reminder that the Client user has received a notification from the Service Provider about delivering an SOW for the Client user’s review is shown and described. Next, in the illustrated embodiment, the Client user may be presented with a screen, at 3002, showing the details about the SOW that was created by the Service Provider selected to work on the Client’s project. The next screen, at 3005, shows the Client user scrolling the view down in order to see additional details of the SOW as well as, e.g., options to agree with the terms and conditions at 3004, and/or to ‘reject’ or ‘accept’ the SOW at 3006, and the like. Once the Client user opens the SOW that is being presented, here, they will be presented with the opportunity to review the SOW in detail. Again, in the embodiment shown, the Client user may be presented with buttons to select to accept or reject this offered SOW by the Service Provider. Once the SOW is in a state that is acceptable to the Client user, then the Client user may select or check an accept button, at 3006, to indicate their acceptance of the terms. Upon selecting the Accept button, processing may proceed, at 3007, to display various features and functionality associated with such acceptance, such as calendaring functionality to schedule an appointment, and communicate their approval of the SOW by the Service Provider. Once that approval has been completed the Client user will be taken to various other screens used or needed given the acceptance of the project’s SOW. Screen 3007 shows one exemplary end screen of the initial user approval process flow for the Client user accepting the SOW from the selected Service Provider, though, again, additional GUIs may then be displayed to provide functionality to accomplish next steps in completing the project.

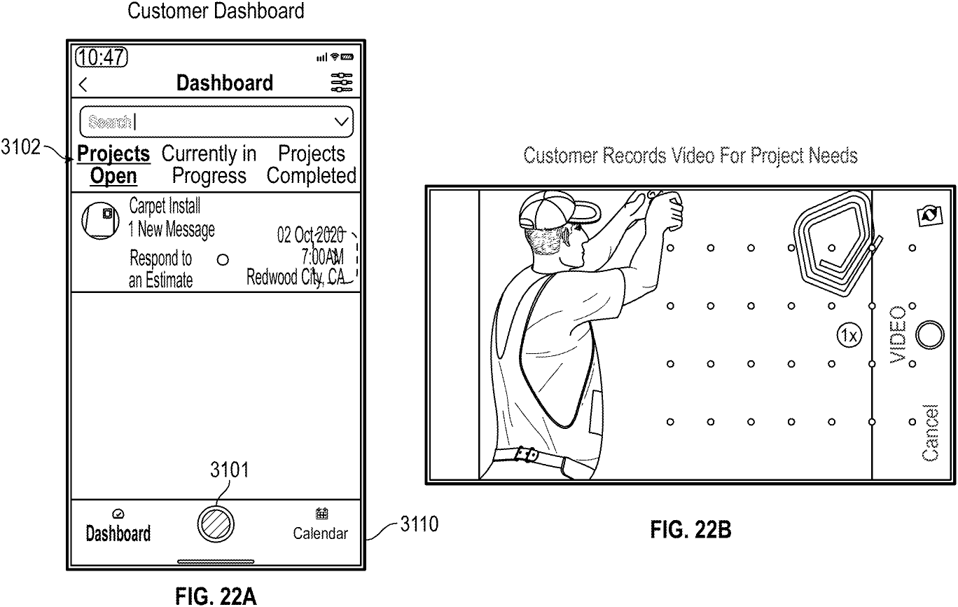

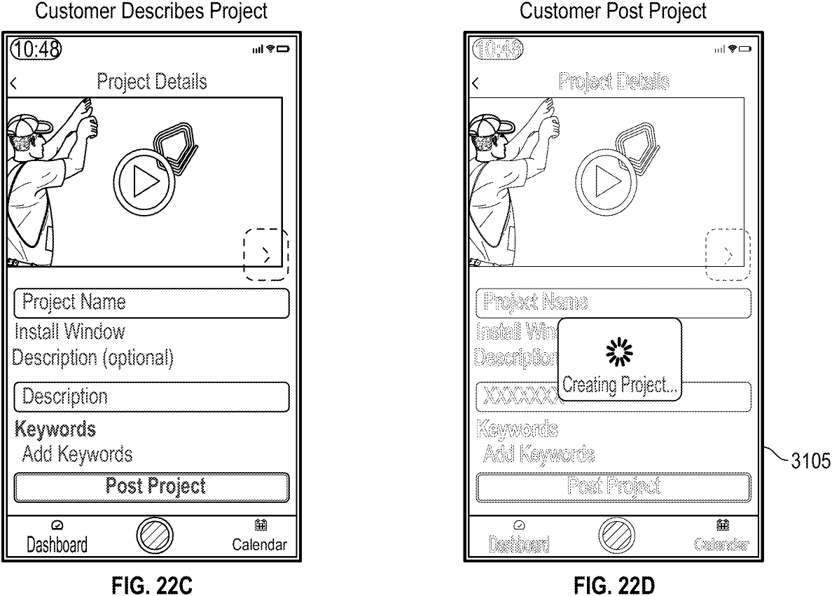

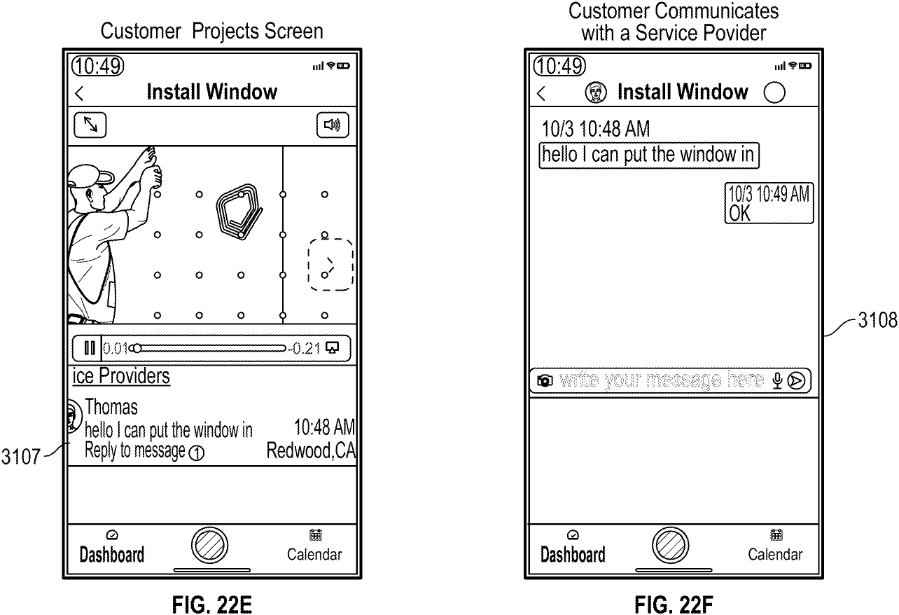

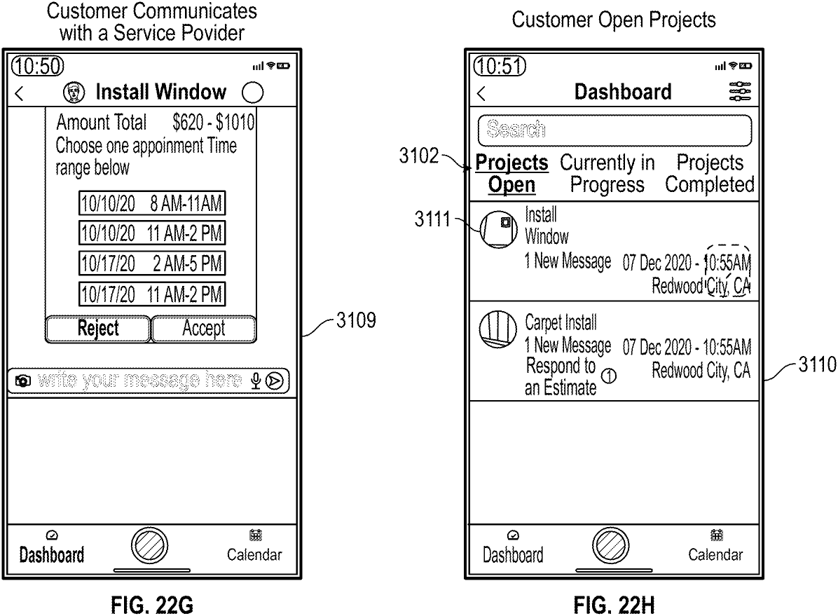

FIGS. 22A-22H depict another exemplary series of GUIs showing an illustrative process for a customer to create, post, receive estimates for a new service project, and thereby open the new service project on the exemplary video-driven service platform, in accordance with certain embodiments of the present disclosure. Here, FIGS. 22A-22H show the interfaces used by the client from the starting point of creating a new project to the point of having the new project estimated at the service platform. A starting point for this user experience is at an exemplary client dashboard screen 3100 as shown in FIG. 22A. Here, dashboard screen 3100 provides the client with multiple choices to interact with and/or manage projects that have been created at the service platform. In this example, as indicated by the “Project Open” tab 3102, dashboard screen 3100 allows the client to access the projects that have been opened and submitted (but not yet completed) by clicking on the “Project Open” table 3102. Similarly, dashboard screen 3100 allows the client to access the projects that are currently in progress by clicking on the greyed out/unselected tab labeled “Currently in Progress”, and/or access the projects that have already been completed by clicking on the greyed out/unselected tab labeled “Projects Completed”.

As illustrated in this example, dashboard screen 3100 displays under the “Project Open” tab 3102 that a carpet install project has been opened with a new message that alerts the client to response to an estimate submitted for this particular open project. Dashboard screen 3100 also displays information about, for example, a timestamp of when the new estimate message was sent and a location indicating where the service provider of the bidding estimate is located.

Here, in addition to the above-described functionality associated with the tabs, the dashboard screen 3100 also functions as a new project creation user interface. For example, the dashboard screen 3100 displays a recording button 3101 to allow the client to start recording a new video in association with creating a new project. By clicking on the button 3101, and as shown in FIG. 22B, the client records a new video to capture the needs for installing a new window, which is a new project.

Subsequently, when the client is done with recording the new video associated with the window installation project, the client navigates to a project details screen 3103 of FIG. 22C to post the newly created project for installing a window. Here, the exemplary project details screen 3103 allows the client to interact with respective user interface elements to, for example, enter a project name, descriptions for the project to be created, and/or keywords describing such project. By clicking on a “Post Project” button 3104, the client creates a new project using the information along with the newly recorded video, and thereby navigates to an uploading screen 3105. As shown in FIG. 22D, at the uploading screen 3105, the client is in a process of creating the new project by, for example, uploading the above-described information of the new project to the service platform.

Once the new project is successfully uploaded via the upload screen 3105, the client navigates to a project screen 3106. As shown in FIG. 22E, this particular project screen 3106 is labeled as an “Install Window” project screen. In this example, once the new project is uploaded, via the same screen 3106, the client is able to communicate with one or more service providers who are able to work on the new project. Here, the project screen 3106 shows that a service provider “Thomas” has sent a message 3107 to the client, indicating that he is able to put the window in. The project screen 3106 also allows the client to reply to the message by, for example, clicking on the message 3107 to navigate to a screen 3108 to exchanges messages with the service provider Thomas. As shown in FIG. 22F, at the screen 3108, the client replies to the message 3107 displayed at the screen 3106 with a message “OK”.

In this example, once the service provider receives the message of interest from the client, the service provider may proceed to communicate further information about servicing the new project. Here, as shown in FIG. 22G, the client receives such further information at a screen 3109, which displays to the client a new message. In this example, the new message informs the client that a total amount is going to between $620-$1010, and four potential appointment time slots are available at 10/10/20 8-11 AM, 10/10/20 11-2 PM, 10/17/20 1-5 PM, and 10/17/20 11-2 PM. Further, at the screen 3109, the client is provided with a “Reject” button and an “Accept” button to respond to the service options communicated from the service provider Thomas.

Here, the client navigate to dashboard screen 3110 without selecting either the Reject button or the Accept button. As shown in FIG. 22H, and compared to the dashboard screen 3100 at which the client starts to create the new project, the dashboard screen 3110 now displays the newly created “Install Window” project 3111 under the “Project Open” tab 3102, in addition to the previously submitted and not yet completed carpet install project.

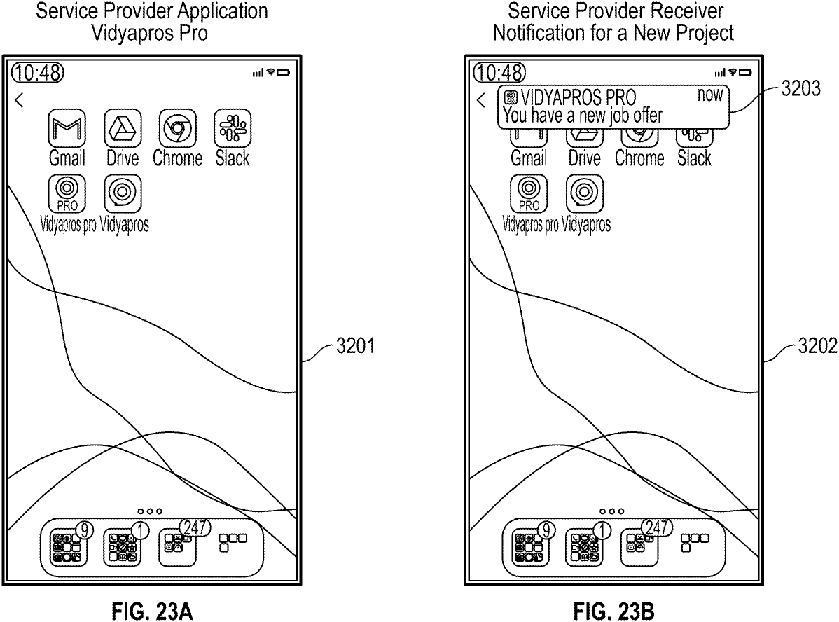

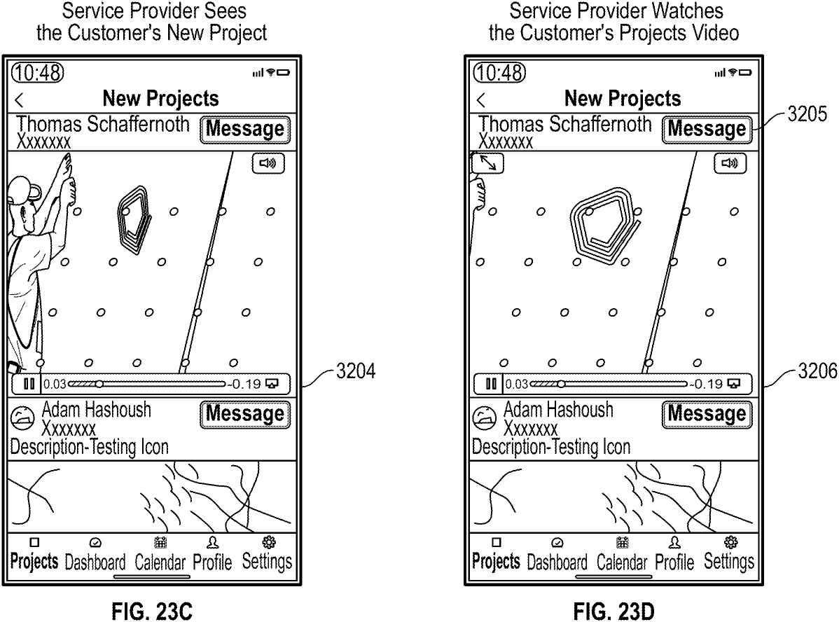

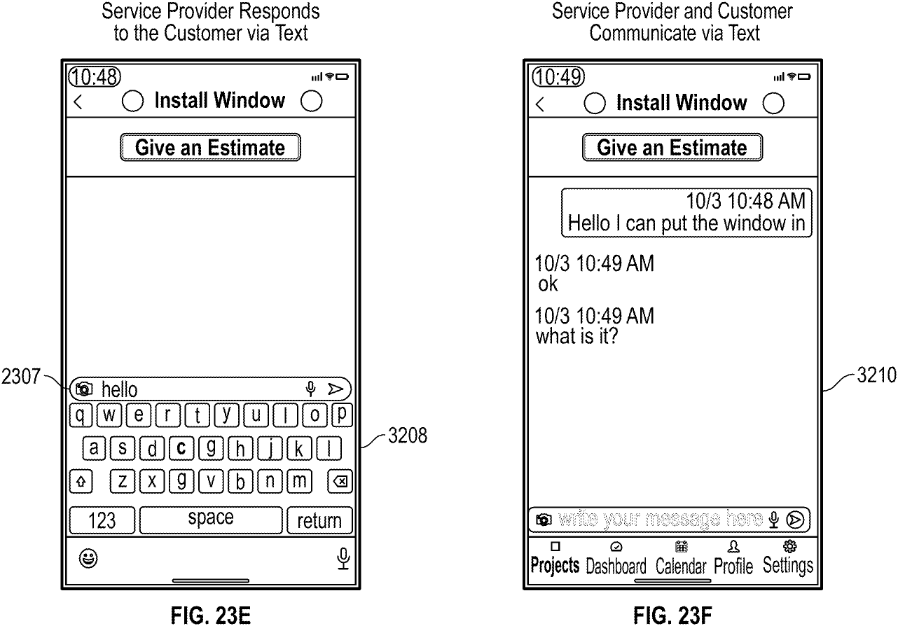

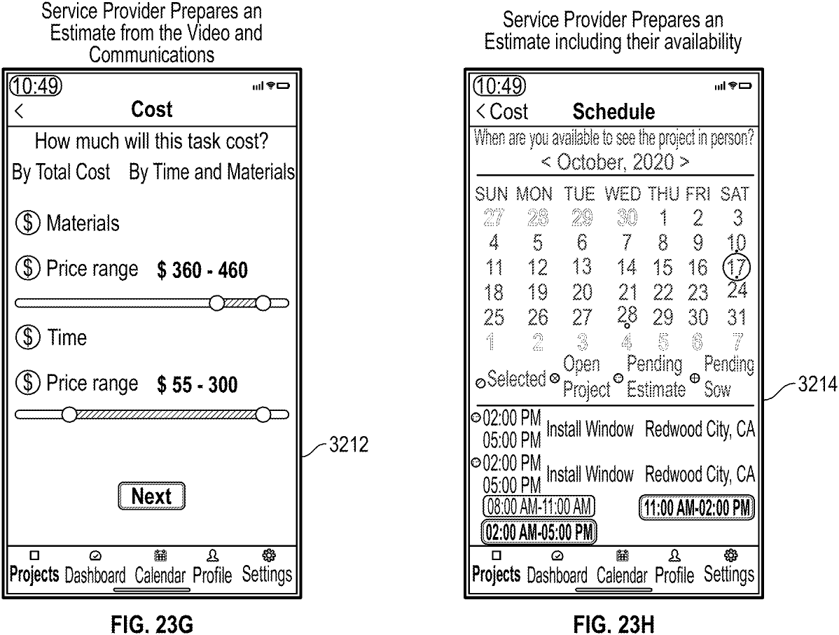

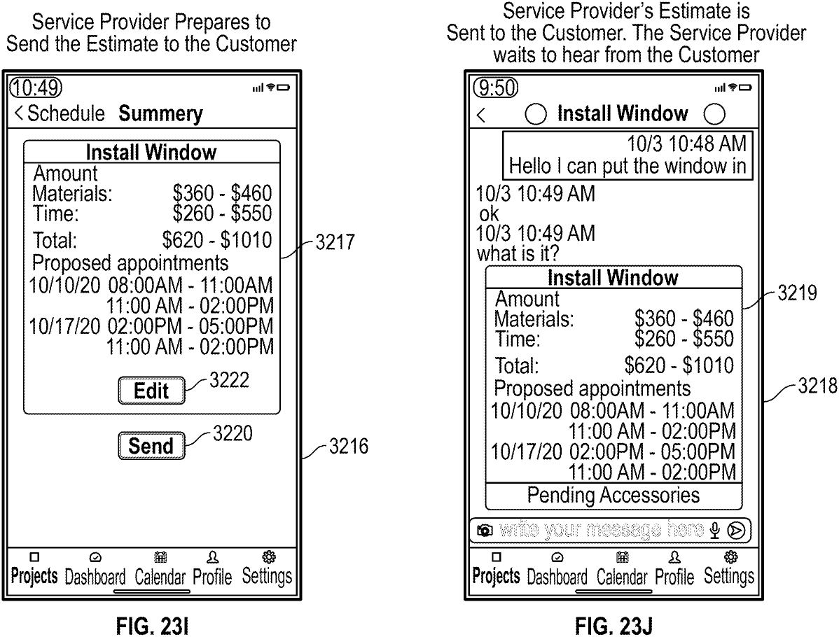

FIGS. 23A-23J depict another exemplary series of GUIs showing an illustrative process for a service provider (e.g., contractor) to receive a notification regarding, and access, a new service project posted on the exemplary video-driven service platform, in accordance with certain embodiments of the present disclosure. Here, FIGS. 23A-23J show the interfaces used by the service provider (e.g., the service provider Thomas of FIGS. 22A-22H) from the starting point of receiving a notification of a new project to the point of having the new project estimate transmitted to the client at the service platform.

A starting point for this user experience is at an exemplary service provider’s mobile phone home screen 3201. As shown in FIG. 23A, the home screen 3201 displays that the service provider has installed the service provider application (e.g., VidyPros Pro) for accessing the service platform. Here, upon a new project uploaded onto the service platform, the home screen 3201 navigates to a home screen 3202 to display a notification 3203 to the service provider. As shown in FIG. 23B, the notification 3203 notifies to the service provider that “You have a new job offer.”

Here, the service provider activates the application to navigate to a new projects screen 3204. At the new projects screen 3204 shown in FIG. 23C, the service provider sees the new project posted by, for example, by the client performing the processes above-described with reference to FIGS. 22A-22H. At a screen 3206 of FIG. 23D, the service provider watches the video uploaded with the new project.

On the same screen 3206 at which the service provider can watch the video associated with the new project, the service provider may select a “Message” button 3205 to navigate to a “Give an Estimate” screen 3208. As shown in FIG. 23E, the service provider starts to message at a messaging box 3207 with the client, who has submitted the new project.

Once the service provider sends the first message to the client, the screen 3208 navigate to a screen 3210. As shown in FIG. 23F, the service provider and the client start to exchange messages with regard to an estimate for the new project. With the client’s interest in this service providers’ estimate, the service provider navigates to a cost screen 3212 to prepare for the cost estimate for the new project. In this example, the cost screen 3212 displays respective GUI elements to allow the service provider to enter estimate information either in the form of a total cost or in the form of a breakdown based on materials/time. As shown in FIG. 223G, the service provider enters the estimate via the “By Time and Materials” tab to enter a price range for cost on materials, and a price range for the time spent. Here, at the cost screen 3212, the service provider may select a Next button to navigate to a schedule screen 3214 to choose one or more date/time available for servicing the new project.

As shown in FIG. 23H, the schedule screen 3214 displays exemplary widgets to allow the service provider to select a date on a calendar, and/or select one or more time windows on a selected day. Here, the schedule screen 3214 displays color coded indicators on the days shown on a current month on the calendar to remind the service provider that, for example, which days are associated with a current selection, open projects, pending estimations, pending SOWs, and the like.

Once done preparing the estimate via the cost screen 3212 and the schedule screen 3214, the service provider navigates to a summary screen 3216. As shown in FIG. 23I, the summary screen 3216 displays to the service provider an “Install Window” dialog 3217, in which the information prepared at the previous screens is summarized for review. Here, the dialog 3217 displays an “edit” button 3222. By clicking on the edit button 3222, the service provider can navigate back to, for example, the cost screen 3212 and/or the schedule screen 3214 to further edit the estimate information prior to sending to the client.

Here, at the summary screen 3216, when the service provider selects a “Send” button 3220, the screen 3216 navigates to a messaging screen 3218. In this example as shown in FIG. 23J, the messaging screen 3218 resumes the conversation thread displayed at the screen 3210 and sends the dialog 3219 to the client. At this point, the service provider awaits to hear back from the client regarding the estimate he submits.

As disclosed herein, implementations and features of the present inventions may be implemented through computer-hardware, software and/or firmware. For example, the systems and methods disclosed herein may be embodied in various forms including, for example, one or more data processors, such as computer(s), server(s) and the like, and may also include or access at least one database, digital electronic circuitry, firmware, software, or in combinations of them. Further, while some of the disclosed implementations describe specific (e.g., hardware, etc.) components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various processes and operations according to the inventions or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the inventions, or it may be more convenient to construct a specialized apparatus or system to perform the required methods and techniques.

In the present description, the terms component, module, device, etc. may refer to any type of logical or functional device, process or blocks that may be implemented in a variety of ways. For example, the functions of various blocks can be combined with one another and/or distributed into any other number of modules. Each module can be implemented as a software program stored on a tangible memory (e.g., random access memory, read only memory, CD-ROM memory, hard disk drive) within or associated with the computing elements, sensors, receivers, etc. disclosed above, e.g., to be read by a processing unit to implement the functions of the innovations herein. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy logic, neural networks, other AI (Artificial Intelligence) or machine learning systems, quantum devices, and hybrids of any of the above device types.

It should also be noted that various logic and/or features disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in tangible various forms (e.g., optical, magnetic or semiconductor storage media), though do not encompass transitory media.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Other implementations of the inventions will be apparent to those skilled in the art from consideration of the specification and practice of the innovations disclosed herein. It is intended that the specification and examples be considered as exemplary only, with a true scope and spirit of the inventions being indicated by the present disclosure and claims and various associated principles of related patent doctrine.

1. A method comprising:
generating a project request including a video, the video describing a project with one or more project details;
transmitting the project request to a server for processing; and
receiving feedback information from the server, the feedback information associated with servicing the project request.

2. The method of claim 1, wherein the feedback information comprises aggregated feedback information from one or more service providers.

3. The method of claim 1, further comprising:
receiving, in response to the transmitted project request, communications from one or more service providers.

4. The method of claim 3, further comprising:
transmitting communications to the one or more service providers.

5. The method of claim 3, wherein the feedback information is received as one of the communications.

6. The method of claim 1, wherein the project request further comprises one or more information items, the one or more information items describing respective project details.

7. The method of claim 6, wherein the one or more information items include at least one of: a project name, a project description, or a project keyword.

8. The method of claim 7, wherein the video is recorded in response to receiving an indication from a user.

9. The method of claims 7, wherein the indication is entered by the user at an application where the user records the video and enters the one or more information items.

10. The method of claim 1, wherein the feedback information comprises an estimate with regard to servicing the project request.

11. The method of claim 1, wherein the estimate comprises at least a cost estimate for servicing the project request and/or a time to finish estimate for servicing the project request.

12. The method of claim 11, wherein the cost estimate is a total cost for servicing the project request.

13. The method of claim 11, wherein the cost estimate includes one or more breakdown costs for servicing the project request.

14. The method of claim 11, further comprising receiving rating information regarding a service provider servicing the project request.

15. The method of claim 1, wherein the video is uploaded for reviewing by one or more service providers who are in a same location as where the project is at, the same location defined by one or more pre-configured criteria.

16. The method of claim 1, wherein the one or more pre-configured criteria includes a distance value.

17. The method of claim 2, wherein the one or more service providers are determined based on monitoring one or more characteristics associating with the one or more service providers accessing the video of the project request.

18. The method of claim 17, wherein monitoring one or more characteristics includes determining which one of the one or more service providers have started watching the video, have been aware of the video but ignore the video, have watching the video to the end, or have watched the video multiple times.

19-21. (canceled)

22. A method comprising:
receiving from a user a project request including a video, the video describing a project with one or more project details;
determining one or more service providers for transmitting the project request;
receiving feedback information from at least one of the one or more service providers, the feedback information associated with servicing the project request.

23-31. (canceled)

32. A method comprising:
receiving, at a computing device of a service provider, a notification of a new project request from a server, the new project request including a video, the video describing a project with one or more project details;
allowing a service provider to access the video to generate feedback information with regard to servicing the new project request; and
transmitting the feedback information to the server.

33-43. (canceled)
